(19) United States
(12) Patent Application Publication
(10) Pub. No.: US 2024/0421893 A1
(43) Pub. Date: Dec. 19, 2024

(54) USER EQUIPMENT AND METHOD FOR HANDLING CELL RESELECTION PROCEDURE

(71) Applicant: FG Innovation Company Limited, Tuen Mun (HK)

(72) Inventors: MING-HUNG TAO, Taipei (TW); CHENG CHIEN-CHUN, Taipei (TW); LIN CHIA-HUNG, Taipei (TW); TSENG YUNG-LAN, Taipei (TW); CHEN HUNG-CHEN, Taipei (TW)

(21) Appl. No.: 18/699,588

(22) PCT Filed: Sep. 30, 2022
(86) PCT No.: PCT/CN2022/123558

§ 371 Date: Apr. 8, 2024

(51) Int. Cl. H04B 7/185; H04W 36/00

(52) U.S. Cl. CPC H04B 7/18513; H04W 36/0005

(57) ABSTRACT

A UE and a method for handling a cell reselection procedure are provided. The method receives, from a camped cell, information related to the cell reselection procedure. The method determines whether the camped cell operates on a first frequency range for a Non-Terrestrial Network (NTN) operation. The method performs a measurement, for the cell reselection procedure for selecting a suitable cell, based on the information related to the cell reselection procedure after determining that the camped cell operates on the first frequency range for the NTN operation.

### CROSS-REFERENCE TO RELATED APPLICATION(S)

This application is the National Stage Application of International Patent Application Serial No. PCT/CN2022/123558, filed on Sep. 30, 2022, which claims the benefit of and priority to U.S. Provisional Patent Application Ser. No. 63/253,735, filed on Oct. 8, 2021, the contents of all which are hereby incorporated herein fully by reference into the present disclosure for all purposes.

### FIELD

The present disclosure is related to wireless communication, and more specifically, to a user equipment (UE) and a method for handling a cell reselection procedure in the next-generation wireless communication network.

### BACKGROUND

With the tremendous growth in the number of connected devices and the rapid increase in user/network traffic volume, various efforts have been made to improve different aspects of wireless communication for the next-generation wireless communication system, such as the fifth-generation (5G) New Radio (NR) system, by improving data rate, latency, reliability, and mobility.

The 5G NR system is designed to provide flexibility and configurability for optimizing the network services and types, thus accommodating various use cases, such as enhanced Mobile Broadband (eMBB), massive Machine-Type Communication (mMTC), and Ultra-Reliable and Low-Latency Communication (URLLC).

However, as the demand for radio access continues to increase, there is a need for further improvements in wireless communication for the next-generation wireless communication system.

### SUMMARY

The present disclosure is related to a method for handling a cell reselection procedure performed by a UE.

According to a first aspect of the present disclosure, a method for handling a cell reselection procedure performed by a UE is provided. The method includes receiving, from a camped cell, information related to the cell reselection procedure; determining whether the camped cell operates on a first frequency range for a Non-Terrestrial Network (NTN) operation; and performing a measurement, for the cell reselection procedure for selecting a suitable cell, based on the information related to the cell reselection procedure after determining that the camped cell operates on the first frequency range for the NTN operation.

In some implementations of the first aspect, the measurement is performed every time period, and the time period is determined based on the information related to the cell reselection procedure.

In some implementations of the first aspect, the time period is determined based on a density level of a Terrestrial Network (TN) deployment indicated by the information related to the cell reselection procedure.

In some implementations of the first aspect, the time period is determined based on area information of a neighboring cell indicated by the information related to the cell reselection procedure.

In some implementations of the first aspect, the time period is determined based on a serving time of the camped cell indicated by the information related to the cell reselection procedure.

In some implementations of the first aspect, the information related to the cell reselection procedure indicates at least one of: one or more frequency ranges, a density level of a TN deployment, area information of a neighboring cell, a serving time of the camped cell, a network operation corresponding to each of the one or more frequency ranges, the network operation being an NTN operation or a TN operation, or a priority corresponding to each of the one or more frequency ranges.

In some implementations of the first aspect, the measurement is performed on at least one of the one or more frequency ranges that is for the TN operation.

In some implementations of the first aspect, the measurement is performed on at least one of the one or more frequency ranges that has a priority higher than a first priority of the first frequency range.

In some implementations of the first aspect, the one or more frequency ranges include a second frequency range for the TN operation and the first frequency range for the NTN operation, and a second priority of the second frequency range is higher than a first priority of the first frequency range.

In some implementations of the first aspect, the information related to the cell reselection procedure is received via system information (SI) broadcast by the camped cell.

In some implementations of the first aspect, the information related to the cell reselection procedure is received via radio resource control (RRC) signaling.

According to a second aspect of the present disclosure, a UE for handling a cell reselection procedure is provided. The UE includes one or more processors and at least one non-transitory computer-readable medium coupled to at least one of the one or more processors, and storing one or more computer-executable instructions that, when executed by the at least one of the one or more processors, cause the UE to receive, from a camped cell, information related to the cell reselection procedure; determine whether the camped cell operates on a first frequency range for an NTN operation; and perform a measurement, for the cell reselection procedure for selecting a suitable cell, based on the information related to the cell reselection procedure after determining that the camped cell operates on the first frequency range for the NTN operation.

### BRIEF DESCRIPTION OF THE DRAWINGS

Aspects of the present disclosure are best understood from the following detailed description when read with the accompanying drawings. Various features are not drawn to scale. Dimensions of various features may be arbitrarily increased or reduced for clarity of discussion.

FIG. 1 is a diagram illustrating wireless communication in an NTN, according to an example implementation of the present disclosure.

FIG. 2A is a diagram illustrating a near-far effect in a TN scenario, according to an example implementation of the present disclosure.

FIG. 2B is a diagram illustrating a near-far effect in an NTN scenario, according to an example implementation of the present disclosure.

FIG. 3 is a flowchart illustrating a method/process for handling a cell reselection procedure performed by a UE, according to an example implementation of the present disclosure.

FIG. 4 is a block diagram illustrating a node for wireless communication, according to an example implementation of the present disclosure.

### DESCRIPTION

Some of the acronyms in the present disclosure are defined as follows and unless otherwise specified, the acronyms have the following meanings:

| Abbreviation | Full name |
|---|---|
| 3GPP | 3^{rd} Generation Partnership Project |
| 5G | 5^{th} Generation |
| 5GC | 5G Core |
| AS | Access Stratum |
| BS | Base Station |
| BSC | Base Station Controller |
| CA | Carrier Aggregation |
| CMAS | Commercial Mobile Alert System |
| CN | Core Network |
| CP | Cyclic Prefix |
| DC | Dual Connectivity |
| DL | Downlink |
| DRX | Discontinuous Reception |
| E-UTRA(N) | Evolved Universal Terrestrial |
| | Radio Access (Network) |
| eMBB | enhanced Mobile Broadband |
| eNB | evolved Node B |
| EN-DC | E-UTRA NR Dual Connectivity |
| EPC | Evolved Packet Core |
| ETWS | Earthquake and Tsunami Warning System |
| GEO | Geostationary Earth Orbiting |
| gNB | Next-Generation Node B |
| GNSS | Global Navigation Satellite System |
| GSM | Global System for Mobile communications |
| HAPS | High Altitude Platform System |
| HEO | High Elliptical Orbiting |
| ID | Identifier/Identity |
| IE | Information Element |
| LDPC | Low-Density Parity-Check |
| LEO | Low Earth Orbiting |
| LTE | Long Term Evolution |
| LTE-A | LTE-Advanced |
| MAC | Medium Access Control |
| MCG | Master Cell Group |
| MeNB | Master eNB |
| MEO | Medium-Earth Orbiting |
| mMTC | massive Machine-Type Communication |
| MN | Master Node |
| MR-DC | Multi-RAT Dual Connectivity |
| MSE | Mobility State Estimation |
| NAS | Non-Access Stratum |
| NB | Node B |
| ng-eNB | next-generation eNB |
| NGC | Next-Generation Core |
| NGSO | Non-GeoSynchronous Orbit |
| NR | New Radio |
| NTN | Non-Terrestrial Networks |
| OFDM | Orthogonal Frequency-Division Multiplexing |
| PBCH | Physical Broadcast Channel |
| PCell | Primary Cell |
| PLMN | Public Land Mobile Network |
| ProSe | Proximity Service |
| PSCell | Primary Secondary Cell/Primary SCG Cell |
| RA | Random Access |
| RAN | Radio Access Network |
| RANU | RAN-based Notification Area update |
| RAT | Radio Access Technology |
| Rel-17 | 3GPP Release 17 |
| RF | Radio Frequency |
| RNA | RAN-Based Notification Area |
| RNC | Radio Network Controller |
| RRC | Radio Resource Control |
| RS | Reference Signal |
| RSRP | Reference Signal Received Power |
| SCell | Secondary Cell |
| SCG | Secondary Cell Group |
| SgNB | Secondary gNB |
| SI | System Information |
| SIB | System Information Block |
| SIB1 | System Information Block Type 1 |
| SIB2 | System Information Block Type 2 |
| SIB3 | System Information Block Type 3 |
| SIB4 | System Information Block Type 4 |
| SL | SideLink |
| SN | Secondary Node |
| SNPN | Stand-Alone Non-Public Network |
| SpCell | Special Cell |
| SR | Scheduling Request |
| SS | Synchronization Signal |
| SSB | SS/PBCH Block |
| SUL | Supplementary Uplink |
| TAU | Tracking Area Update |
| TS | Technical Specification |
| UAS | Unmanned Aircraft System |
| UE | User Equipment |
| UL | Uplink |
| UMTS | Universal Mobile Telecommunications System |
| URLLC | Ultra-Reliable Low-Latency Communication |
| UTRAN | Universal Terrestrial Radio Access Network |
| V2X | Vehicle-to-Everything |
| WI | Working Item |

The following contains specific information related to example implementations of the present disclosure. The drawings and their accompanying detailed description are merely directed to example implementations. However, the present disclosure is not limited to these example implementations. Other variations and implementations of the present disclosure will be obvious to those skilled in the art.

Unless noted otherwise, like or corresponding elements among the drawings may be indicated by like or corresponding reference designators. Moreover, the drawings and illustrations in the present disclosure are generally not to scale, and are not intended to correspond to actual relative dimensions.

For the purposes of consistency and ease of understanding, like features may be identified (although, in some examples, not illustrated) by the same reference designators in the drawings. However, the features in different implementations may differ in other respects and may not be narrowly confined to the implementations illustrated in the drawings.

The phrases “in one implementation,” or “in some implementations,” may each refer to one or more of the same or different implementations. The term “coupled” is defined as connected whether directly or indirectly via intervening components and is not necessarily limited to physical connections. The term “comprising” means “including, but not necessarily limited to” and specifically indicates open-ended inclusion or membership in the disclosed combination, group, series or equivalent. The expression “at least one of A, B and C” or “at least one of the following: A, B and C” means “only A, or only B, or only C, or any combination of A, B and C.”

The terms “system” and “network” may be used interchangeably. The term “and/or” is only an association relationship for disclosing associated objects and represents that three relationships may exist. For example, A and/or B may indicate that A exists alone, A and B exist at the same time, or B exists alone. “A and/or B and/or C” may represent that at least one of A, B, and C exists. The character “/” generally represents that the associated objects are in an “or” relationship.

The terms “if”, “in a case that”, “while”, “when”, “after”, “upon”, and “once” may be used interchangeably. The terms “according to”, “based on”, “through”, and “via” may be used interchangeably.

The terms “determine”, “decide”, and “select” may be used interchangeably. The terms “determined”, “defined”, “configured”, “given”, “predetermined”, “predefined”, “preconfigured”, and “pre-given” may be used interchangeably. The terms “operate”, “implement”, and “perform” may be used interchangeably.

For the purposes of explanation and non-limitation, specific details, such as functional entities, techniques, protocols, standards, and the like, are set forth for providing an understanding of the disclosed technology. In other examples, detailed disclosure of well-known methods, technologies, systems, architectures, and the like are omitted so as not to obscure the present disclosure with unnecessary details.

Persons skilled in the art will immediately recognize that any disclosed network function(s) or algorithm(s) may be implemented by hardware, software or a combination of software and hardware. Disclosed functions may correspond to modules which may be software, hardware, firmware, or any combination thereof.

A software implementation may include computer-executable instructions stored on a computer-readable medium, such as memory or other types of storage devices. One or more microprocessors or general-purpose computers with communication processing capability may be programmed with corresponding executable instructions and perform the disclosed network function(s) or algorithm(s).

The microprocessors or general-purpose computers may include Application-Specific Integrated Circuits (ASICs), programmable logic arrays, and/or one or more Digital Signal Processors (DSPs). Although some of the disclosed implementations are oriented to software installed and executing on computer hardware, alternative example implementations implemented as firmware, as hardware, or as a combination of hardware and software are well within the scope of the present disclosure.

The computer-readable medium may include, but is not limited to, Random Access Memory (RAM), Read-Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture, such as an LTE system, an LTE-A system, an LTE-Advanced Pro system, or a 5G NR RAN may typically include at least one BS, at least one UE, and one or more optional network elements that provide connection within a network. The UE may communicate with the network, such as a CN, an EPC network, an E-UTRAN, an NGC, a 5GC, or an internet via a RAN established by one or more BSs.

A UE may include, but is not limited to, a mobile station, a mobile terminal or device, or a user communication radio terminal. The UE may be a portable radio equipment that includes, but is not limited to, a mobile phone, a tablet, a wearable device, a sensor, a vehicle, or a Personal Digital Assistant (PDA) with wireless communication capability. The UE may be configured to receive and transmit signals over an air interface to one or more cells in a RAN.

The BS may be configured to provide communication services according to at least an RAT, such as Worldwide Interoperability for Microwave Access (WiMAX), Global System for Mobile communications (GSM that is often referred to as 2G), GSM Enhanced Data rates for GSM Evolution (EDGE) RAN (GERAN), General Packet Radio Service (GPRS), Universal Mobile Telecommunication System (UMTS that is often referred to as 3G) based on basic Wideband-Code Division Multiple Access (W-CDMA), High-Speed Packet Access (HSPA), LTE, LTE-A, evolved/enhanced LTE (eLTE) that is LTE connected to 5GC, NR (often referred to as 5G), and/or LTE-A Pro. However, the scope of the present disclosure is not limited to these protocols.

The BS may include, but is not limited to, an NB in the UMTS, an eNB in LTE or LTE-A, an RNC in UMTS, a BSC in the GSM/GERAN, an ng-eNB in an E-UTRA BS in connection with 5GC, a gNB in the 5G-RAN (or in the 5G Access Network (5G-AN)), or any other apparatus capable of controlling radio communication and managing radio resources within a cell. The BS may serve one or more UEs via a radio interface.

The BS may be operable to provide radio coverage to a specific geographical area using a plurality of cells included in the RAN. The BS may support the operations of the cells. Each cell may be operable to provide services to at least one UE within its radio coverage.

Each cell (often referred to as a serving cell) may provide services to serve one or more UEs within its radio coverage such that each cell schedules the DL and optionally UL resources to at least one UE within its radio coverage for DL and optionally UL packet transmissions. The BS may communicate with one or more UEs in the radio communication system via the plurality of cells.

A cell may allocate SL resources for supporting ProSe, LTE SL services, and/or LTE/NR V2X services. Each cell may have overlapped coverage areas with other cells.

In MR-DC cases, the primary cell of an MCG or an SCG may be called an SpCell. A PCell may refer to the SpCell of an MCG. A PSCell may refer to the SpCell of an SCG. An MCG may refer to a group of serving cells associated with the MN, including the SpCell and optionally one or more SCells. An SCG may refer to a group of serving cells associated with the SN, including the SpCell and optionally one or more SCells.

As disclosed above, the frame structure for NR supports flexible configurations for accommodating various next-generation (e.g., 5G) communication requirements, such as eMBB, mMTC, and URLLC, while fulfilling high reliability, high data rate and low latency requirements. The OFDM technology in the 3GPP may serve as a baseline for an NR waveform. The scalable OFDM numerology, such as adaptive sub-carrier spacing, channel bandwidth, and CP may also be used.

Two coding schemes are considered for NR, specifically LDPC code and Polar Code. The coding scheme adaption may be configured based on channel conditions and/or service applications.

At least DL transmission data, a guard period, and an UL transmission data should be included in a transmission time interval (TTI) of a single NR frame. The respective portions of the DL transmission data, the guard period, and the UL transmission data should also be configurable (e.g., based on the network dynamics of NR). SL resources may also be provided in an NR frame to support ProSe services, V2X services (e.g., E-UTRA V2X SL communication services) or SL services (e.g., NR SL communication services). In contrast, SL resources may also be provided in an E-UTRA frame to support ProSe services, V2X services (e.g., E-UTRA V2X SL communication services) or SL services (e.g., NR SL communication services).

Multiple PLMNs may operate on an unlicensed spectrum. Multiple PLMNs may share the same unlicensed carrier. The PLMNs may be public or private. Public PLMNs may be (but are not limited to) operators or virtual operators, which provide radio services to public subscribers. Public PLMNs may own a licensed spectrum and support an RAT on the licensed spectrum as well. Private PLMNs may be (but are not limited to) micro-operators, factories, or enterprises, which provide radio services to its private users (e.g., employees or machines). Public PLMNs may support more deployment scenarios (e.g., CA between licensed band NR (PCell) and NR-Unlicensed (NR-U) (SCell), DC between licensed band LTE (PCell) and NR-U (PSCell), stand-alone NR-U, an NR cell with DL in an unlicensed band and UL in a licensed band, DC between licensed band NR (PCell) and NR-U (PSCell)). Private PLMNs may support (but are not limited to) stand-alone unlicensed RAT (e.g., stand-alone NR-U).

Any two or more than two of the following sentences, paragraphs, (sub)-bullets, points, actions, behaviors, terms, alternatives, aspects, examples, or claims described in the following disclosure may be combined logically, reasonably, and properly to form a specific method.

Any sentence, paragraph, (sub)-bullet, point, action, behaviors, terms, alternatives, aspects, examples, or claims described in the following disclosure may be implemented independently and separately to form a specific method.

Dependency (e.g., “based on”, “more specifically”, “preferably”, “In one embodiment”, “In some implementations”, “In one alternative”, “In one example”, “In one aspect”, or etc.) in the following disclosure is just one possible example which may not restrict the specific method.

Example descriptions of some selected terms, examples, embodiments, implementations, actions, and/or behaviors used in the present disclosure are given as follows.

The terms “network”, “RAN”, “cell”, “camped cell”, “serving cell”, “BS”, “gNB”, “eNB” and “ng-eNB” may be used interchangeably. In some implementations, some of these items may refer to the same network entity.

Cell: A cell may be a radio network object that may be uniquely identified by a UE from a (cell) identification that is broadcast over a geographical area from one UTRAN Access Point. The Cell may be either in an FDD or a TDD mode.

Serving cell: In some implementations, a serving cell may be the cell providing services to a UE while the UE is in an RRC_CONNECTED, RRC_INACTIVE, or RRC_IDLE state. For a UE in an RRC connected state (e.g., RRC_CONNECTED state) that is not configured with CA or DC, there may be only one serving cell, which may be referred to as a PCell. For a UE in the RRC_CONNECTED state configured with CA or DC, the term “serving cells” may be used to denote a set of cells including SpCell(s) and all SCells. For example, the serving cell may be a PCell, a PSCell, or an SCell, as described, for example, in the TS 38.331.

A UE (operating) in an RRC connected state (e.g., RRC_CONNECTED state) may be referred to as an RRC_CONNECTED UE. A UE (operating) in an RRC idle state (e.g., RRC_IDLE state) may be referred to as an RRC_IDLE UE. A UE (operating) in an RRC inactive state (e.g., RRC_INACTIVE state) may be referred to as an RRC_INACTIVE UE.

Serving frequency: In some implementations, a serving frequency may include a frequency in which a serving cell operates.

SpCell: For a DC operation, the term SpCell may refer to a PCell of an MCG or a PSCell of an SCG. Otherwise, the term SpCell may refer to the PCell.

MR-DC: An MR-DC may be a DC between E-UTRA and NR nodes, or between two NR nodes. The MR-DC may include an EN-DC, an NR-E-UTRA Dual Connectivity (NE-DC), an NG-RAN E-UTRA-NR Dual Connectivity (NGEN-DC), and an NR-NR Dual Connectivity (NR-DC) (mode).

MCG: An MCG may be, in the MR-DC, a group of serving cells associated with an MN including an SpCell (e.g., a PCell) and optionally one or more SCells.

MN: An MN may be, in the MR-DC, a radio access node that provides a control plane connection to a CN. The MN may be a Master eNB (e.g., in EN-DC), a Master ng-eNB (e.g., in NGEN-DC), or a Master gNB (e.g., in NR-DC and NE-DC).

SCG: An SCG may be, in the MR-DC, a group of serving cells associated with an SN including an SpCell (e.g., a PSCell) and optionally one or more SCells.

SN: An SN may be, in the MR-DC, a radio access node, with no control plane connection to a CN, providing additional resources to a UE. The SN may be an en-gNB (e.g., in EN-DC), a Secondary ng-eNB (e.g., in NE-DC), or a Secondary gNB (e.g., in NR-DC and NGEN-DC).

MeNB: An MeNB may be an eNB as a master node associated with an MCG in the MR-DC (scenarios).

gNB: In some implementations, a gNB may include (but is not limited to) a node that provides, to a UE, the NR user plane and control plane termination protocols, and that is connected, for example, via an NG interface, to the 5GC.

SgNB: An SgNB may be a gNB as a secondary node associated with an SCG in the MR-DC (scenarios).

CSI: In some implementations, the CSI may include CQIs as well as a MIMO-related feedback. The MIMO-related feedback may include a rank indicator (RI), a precoding matrix indicator (PMI), etc.

SR: In some implementations, an SR may be used by a UE to request the UL resource(s).

FR1: In some implementations, an FR1 may be the frequency range defined between 410 MHz to 7125 MHz.

FR2: In some implementations, an FR2 may be the frequency range defined between 24250 MHz to 52600 MHz.

Intra-frequency measurement: In some implementations, the intra-frequency measurement may be the measurement associated with the signal strength/quality/power of the RS emitted using the frequency the same as the serving frequency.

Inter-frequency measurement: In some implementations, the inter-frequency measurement may be the measurement associated with the signal strength/quality/power of the RS emitted using a frequency different from the serving frequency.

Inter-RAT measurement: In some implementations, the inter-RAT measurement may be the measurement associated with the signal strength/quality/power of the RS emitted using a RAT different from the NR.

NTN: In some implementations, an NTN may refer to network(s) or segments of a network(s) using a spaceborne vehicle for transmission, such as at least one of LEO satellites, GNSS satellites, or GEO satellites. In the 3GPP Rel-17 NTN WI, a transparent payload-based LEO scenario may address at least the 3GPP class 3 UE with the GNSS capability. The NTN may include an NG-RAN including the gNBs, which provide non-terrestrial NR access to the UEs by means of an NTN payload embarked on an airborne or spaceborne NTN vehicle and an NTN Gateway.

Earth moving cell: In some implementations, an earth moving cell may be the NTN cell with respect to continuously moving geographic area on earth. This may be provisioned by beam(s) which foot print slides over the earth surface (e.g., in the case of NGSO satellites generating fixed or non-steerable beams).

Quasi earth fixed cell: In some implementations, a quasi earth moving cell may be the NTN cell fixed with respect to a specific geographic area on earth during a specific time duration. This may be provided by beam(s) covering one geographic area for a finite period and a different geographic area during another period (e.g., in the case of NGSO satellites generating steerable beams).

SI may refer to the MIB, SIB1, and other SI. Minimum SI may include the MIB and SIB1. Other SI may refer to the SIB2, SIB3, SIB4, SIB5, and other SIB(s) (e.g., SNPN-specific SIB, PNI-NPN-specific SIB).

Dedicated signaling may refer to (but is not limited to) the RRC message(s). For example, the RRC message(s) may include an RRC (Connection) Setup Request message, RRC (Connection) Setup message, RRC (Connection) Setup Complete message, RRC (Connection) Reconfiguration message, RRC Connection Reconfiguration message including the mobility control information, RRC Connection Reconfiguration message without the mobility control information inside, RRC Reconfiguration message including the configuration with sync, RRC Reconfiguration message without the configuration with sync inside, RRC (Connection) Reconfiguration complete message, RRC (Connection) Resume Request message, RRC (Connection) Resume message, RRC (Connection) Resume Complete message, RRC (Connection) Reestablishment Request message, RRC (Connection) Reestablishment message, RRC (Connection) Reestablishment Complete message, RRC (Connection) Reject message, RRC (Connection) Release message, RRC System Information Request message, UE Assistance Information message, UE Capability Enquiry message, and UE Capability Information message. RRC message may be one kind of dedicated signaling. The UE may receive the RRC message from the network via unicast/broadcast/groupcast.

The disclosed mechanisms may be applied to any RAT. The RAT may be (but is not limited to) NR, NR-U, LTE, E-UTRA connected to the 5GC, LTE connected to 5GC, E-UTRA connected to EPC, and LTE connected to EPC. The disclosed mechanisms may be applied to the UEs in public networks, or in private networks (e.g., NPN, SNPN, and PNI-NPN).

The disclosed mechanisms may be used for licensed frequency and/or unlicensed frequency.

Generally, the disclosed mechanisms may be applied for the PCell and the UE. In addition, the mechanisms described in the present disclosure may be applied for the PSCell and the UE.

In the present disclosure, the terms “TN” and “TN (cell)” may be used interchangeably. The terms “NTN” and “NTN (cell)” may be used interchangeably. The terms “frequency range” and “frequency” may be used interchangeably. The terms “frequency for TN (cell)” and “frequency supporting TN (cell)” may be used interchangeably. The terms “frequency of TN (cell)” and “frequency operated by TN (cell)” may be used interchangeably. In addition, the terms “frequency for NTN (cell)” and “frequency supporting NTN (cell)” may be used interchangeably. The terms “frequency of NTN (cell)” and “frequency operated by NTN (cell)” may be used interchangeably.

In the present disclosure, a UE camped on an NTN (cell) may be referred to as an NTN UE or an NTN capable UE. A UE camped on a TN (cell) may be referred to as a TN UE or a TN capable UE.

### Cell Selection and Reselection in RRC_IDLE and RRC_INACTIVE States

In some implementations, an RRC_IDLE UE and RRC_INACTIVE UE may (need to) perform the procedures that may be divided into the following three categories:
PLMN selection (for a UE not operating in an SNPN access mode) or SNPN selection (for a UE operating in an SNPN access mode),
Cell selection and reselection,
Location registration/tracking area update and RNA update.

In some implementations, PLMN selection, SNPN selection, cell reselection procedures, and location registration may be common for both the RRC_IDLE and RRC_INACTIVE states. The RNA update may only be applicable for the RRC_INACTIVE state.

In some implementations, when the UE is switched on, a PLMN or an SNPN may be selected by a NAS (e.g., of the UE). Then, the NAS may provide a list of equivalent PLMNs (if available) that an AS (e.g., of the UE) uses for cell selection and cell reselection. During the cell selection, the UE may search for a suitable cell of the selected PLMN or the selected SNPN, select the cell (that provides available services), and monitor its control channel(s). The above procedure may be referred to as “camping on the cell”.

Then, the UE may perform an NAS registration procedure in the tracking area of the selected cell. After (e.g., as a result of) a successful NAS registration procedure, the selected PLMN/SNPN may then become the registered PLMN/SNPN. Afterward, if the UE finds a new cell (e.g., a more suitable cell) according to the cell reselection criteria, the UE may reselect the new cell and camp on it.

In some implementations, if the new cell does not belong to at least one tracking area with which the UE is registered, a location registration (e.g., tracking area update) may be performed. For the RRC_INACTIVE UE, if the new cell does not belong to the configured RNA, an RNA update procedure may be performed.

In some implementations, camping on a cell in the RRC_IDLE or RRC_INACTIVE state may facilitate at least one of the following operations.
It may enable the UE to receive the SI from the PLMN or the SNPN.
When registered and if the UE intends to establish an RRC connection or resume a suspended RRC connection, it may (immediately) access a network on/via a control channel of the cell on which it camps.
In case an incoming call or data is targeting the UE in the RRC_IDLE or RRC_INACTIVE state, the network may page the UE by delivering the paging messages to the set of tracking areas (e.g., in the RRC_IDLE state) or RNA (e.g., in the RRC_INACTIVE state) with which the UE is registered. After (or upon) receiving the paging message, the UE may perform an RRC connection establishment procedure (e.g., in the RRC_IDLE state) or an RRC resume procedure (e.g., in the RRC_INACTIVE state) in order to enter the RRC_CONNECTED state in the camped cell.
It may enable the UE to receive the ETWS and CMAS notifications.

In some implementations, while in the RRC_IDLE or RRC_INACTIVE state, the UE may perform the measurements for the cell selection and reselection purposes.

In some implementations, one of the following types of cell selection may be performed.

Initial cell selection (without prior knowledge of which RF channels are the NR frequencies):
The UE may scan all the RF channels in the NR bands according to its capabilities to find a suitable cell.
On each frequency, the UE may (only need to) search for the strongest cell, except for the operation with shared spectrum channel access where the UE may (need to) search for the next strongest cell(s).
Once the suitable cell is found, this cell may be selected.

Cell selection by leveraging stored information:
This procedure may require the stored information of the frequencies and may also optionally need information regarding the cell parameters from previously received measurement control information elements or from previously detected cells.
Once the UE has found the suitable cell, this cell may be selected.
If no suitable cell is found, the initial cell selection procedure may be started.

In some implementations, the UE may use the cell selection criterion S to find a suitable cell. A cell fulfilling the cell selection criterion S may be considered as the suitable cell. The cell selection criterion S may be fulfilled when:

Srxlev>0 and Squal>0,

where:

$$Srxlev = {Q}_{rxlevmeas} - ( {Q}_{rxlevmin} + {Q}_{rxlevminoffset} ) - {P}_{compensation} - {Qoffset}_{temp} , and$$

$$Squal = {Q}_{qualmeas} - ( {Q}_{q ualmin} + {Q}_{qualminoffset} ) - {Qoffset}_{temp}$$

where:

| | |
|---|---|
| Srxlev | Cell selection Receive (RX) level value (dB) |
| Squal | Cell selection quality value (dB) |
| Qoffsetₜₑₘₚ | Offset temporarily applied to a cell (dB) |
| Qᵣₓₗₑᵥₘₑₐₛ | Measured cell RX level value (RSRP) |
| Q_{qualmeas} | Measured cell quality value (RSRQ) |
| Qᵣₓₗₑᵥₘᵢₙ | Minimum required RX level in the |
| | cell (dBm). If the UE supports |
| | Supplementary Uplink (SUL) frequency |
| | for this cell, Qrxlevmin is obtained |
| | from q-RxLevMin-sul, if present, in SIB1, |
| | SIB2 and SIB4, additionally, if |
| | Q_{rxlevminoffsetcellSUL} is present in SIB3 and |
| | SIB4 for the concerned cell, this cell |
| | specific offset is added to the |
| | corresponding Qrxlevmin to achieve the |
| | required minimum RX level in the |
| | concerned cell; else Qrxlevmin is obtained |
| | from q-RxLevMin in SIB1, SIB2 and |
| | SIB4, additionally, if Q_{rxlevminoffsetcell} is |
| | present in SIB3 and SIB4 for the concerned |
| | cell, this cell specific offset is |
| | added to the corresponding Qrxlevmin to |
| | achieve the required minimum RX |
| | level in the concerned cell. |
| Q_{qualmin} | Minimum required quality level in the cell |
| | (dB). Additionally, if Q_{qualminoffsetcell} |
| | is signaled for the concerned cell, this |
| | cell specific offset is added to achieve |
| | the required minimum quality level |
| | in the concerned cell. |
| Q_{rxlevminoffset} | Offset to the signaled Qᵣₓₗₑᵥₘᵢₙ taken into |
| | account in the Srxlev evaluation as |
| | a result of a periodic search for a higher |
| | priority PLMN while camped |
| | normally in a Visited PLMN (VPLMN) |
| Q_{qualminoffset} | Offset to the signaled Q_{qualmin} taken into |
| | account in the Squal evaluation as a |
| | result of a periodic search for a higher |
| | priority PLMN while camped normally |
| | in a VPLMN |
| P_{compensation} | If the UE supports the additionalPmax |
| | in the NS-PmaxList, if present, in |
| | SIB1, SIB2 and SIB4: |
| | max(P_{EMAX1} − P_{PowerClass}, 0) − (min(P_{EMAX2}, |
| | P_{PowerClass}) − min(P_{EMAX1}, |
| | P_{PowerClass})) (dB); |
| | else: |
| | max(P_{EMAX1} − P_{PowerClass}, 0) (dB) |
| P_{EMAX1}, | Maximum TX power level of a UE may |
| P_{EMAX2} | use when transmitting on the uplink |
| | in the cell (dBm) defined as P_{EMAX}. |
| | If UE supports SUL frequency for this |
| | cell, P_{EMAX1} and P_{EMAX2} are obtained |
| | from the p-Max for SUL in SIB1 and |
| | NR-NS-PmaxList for SUL respectively |
| | in SIB1, SIB2 and SIB4, else |
| | P_{EMAX1} and P_{EMAX2} are obtained from |
| | the p-Max and NR-NS-PmaxList |
| | respectively in SIB1, SIB2 and SIB4 |
| | for normal UL. |
| P_{PowerClass} | Maximum RF output power of the UE |
| | (dBm) according to the UE power |
| | class. |

In some implementations, for cell reselection purposes, (absolute) priorities of different NR frequencies or inter-RAT frequencies may be provided to the UE via/in the SI, in the dedicated signaling (e.g., an RRCRelease message), or by inheriting from another RAT during the inter-RAT cell (re) selection. Then, the UE may (tend to) camp on the cell operating on the higher-priority frequency than the cell operating on the lower-priority frequency. If the priorities are provided in the dedicated signaling, the UE may ignore (all) the priorities provided in the SI. If the UE is in the “camped on any cell state,” the UE may (only) apply the priorities provided by the SI from the current cell. The UE may (only) perform cell reselection evaluation for the NR frequencies and inter-RAT frequencies that are provided in the SI and for which the UE has a priority. In case the UE receives the RRCRelease message with the deprioritisationReq (including the deprioritisationType), the UE may consider the current frequency (if the deprioritisationType=frequency) or (all) the frequencies of NR (if the deprioritisationType=NR) to be the lowest priority frequency (e.g., lower than any of the network configured values) while the timer (e.g., T325) is running irrespective of the camped RAT. The UE may search for a higher priority layer for cell reselection (once) after the change of priority. The UE may delete priorities provided by the dedicated signaling when at least one of the following conditions occurs:
the UE enters a different RRC state,
the optional validity time of the dedicated priorities (e.g., T320) expires,
the UE receives the RRCRelease message with the field cellReselectionPriorities absent, or
a PLMN selection or SNPN selection is performed on request by a NAS (e.g., of the UE).

In some implementations, the UE may not consider any black listed cell as a candidate for the cell reselection. The UE may consider (only) white listed cell(s) (if configured) as candidate(s) for the cell reselection.

In some implementations, as long as the UE has camped on the current serving cell for more than 1 second and a threshold value (e.g., threshServingLowQ) is broadcast in the SI, the UE may reselect another NR/E-UTRAN cell operating on a higher-priority frequency if that cell fulfills Squal>Thresh_{X, HighQ} during a time interval Treselection_{RAT} (e.g., Treselection_{NR} or Treselection_{EUTRA}). Otherwise, the UE may reselect another NR/EUTRAN/other-RAT cell operating on the higher-priority frequency if that cell fulfills Srxlev>Thresh_{X, HighP} during the time interval Treselection_{RAT}.

In some implementations, as long as the UE has camped on the current serving cell for more than 1 second and a threshold value (e.g., threshServingLowQ) is broadcast in the SI, the UE may reselect another NR/EUTRAN/other-RAT cell operating on a lower-priority frequency if at least one of the following conditions occurs:
The target cell fulfills Squal>Thresh_{X, LowQ} and the serving cell fulfills Squal<Thresh_{Serving, LowQ} during a time interval Treselection_{RAT}, or
The target cell fulfills Srxlev>Thresh_{X, LowP} and the serving cell fulfills Srxlev<Thresh_{Serving, LowP} during the time interval Treselection_{RAT}.

In some implementations, the UE may evaluate the ranking of each neighboring cell (Rₙ) fulfilling the cell selection criterion S and operating on the same frequency as the serving cell, or operating on a different frequency having the same priority as the serving frequency (e.g., the frequency on which the current serving cell operates), based on the following rule/formula.

$${R}_{n} = {Q}_{meas , n} - Qoffset - {Qoffset}_{t e m p} ,$$

where:

| | |
|---|---|
| Qₘₑₐₛ | RSRP measurement quantity used in cell reselections. |
| Qoffset | For intra-frequency: Equals to Qoffset_{s,n}, |
| | if Qoffset_{s,n} is valid, otherwise this |
| | equals to zero. |
| | For inter-frequency: Equals to Qoffset_{s,n} |
| | plus Qoffset_{frequency}, if Qoffset_{s,n} is |
| | valid, otherwise this equals to Qoffset_{frequency}. |
| Qoffsetₜₑₘₚ | Offset temporarily applied to a cell as |
| | specified in the TS 38.331. |

In some implementations, the UE may evaluate the ranking of the serving cell (Rₛ) based on the following rule/formula.

$${R}_{s} = {Q}_{meas , s} + {Q}_{hyst} - {Qoffset}_{temp} ,$$

where Q_{hyst} is the hysteresis value for ranking criteria.

Then, the UE may perform cell reselection to switch to the highest-ranked cell (e.g., the cell having the highest R value) if at least one of the following conditions occurs:
the to be switched to cell is not the current serving cell,
the to be switched to cell is better than the current serving cell during the time interval Treselection_{RAT}, or
more than 1 second has elapsed since the UE camped on the current serving cell.

In some implementations, cell reselection to switch to a higher priority RAT/frequency may take precedence over a lower priority RAT/frequency if multiple cells of different priorities fulfill the cell reselection criteria.

### Measurement Rules and Requirements in RRC_IDLE and RRC_INACTIVE States

In some implementations, the UE may (need to) keep measuring the neighboring cells/frequencies in order to evaluate the ranking of the neighboring cells for the cell reselection purposes. The following rules may be used by the UE to limit the needed measurements (and thus, to save the UE's power consumption).

In some implementations, if the serving cell fulfills Srxlev>S_{IntraSearchP} and Squal>S_{IntraSearchQ}, the UE may determine (e.g., choose) not to perform the intra-frequency measurements. Otherwise, the UE may perform the intra-frequency measurements.

The UE may apply the following rules for the NR inter-frequencies and inter-RAT frequencies which are indicated in the SI and for which the UE has priority.

In some implementations, for an NR inter-frequency or inter-RAT frequency with a reselection priority higher than a reselection priority of the current (serving) NR frequency, the UE may perform the measurements of (or on) higher priority NR inter-frequencies or inter-RAT frequencies (e.g., according to the TS 38.133).

In some implementations, for an NR inter-frequency with an equal or lower reselection priority than the reselection priority of the current (serving) NR frequency and for an inter-RAT frequency with a lower reselection priority than the reselection priority of the current (serving) NR frequency:
If the serving cell fulfills Srxlev>S_{nonIntraSearchP} and Squal>S_{nonIntraSearchQ}, the UE may determine (e.g., choose) not to perform the measurements of NR inter-frequency cells with the equal or lower priority, or inter-RAT frequency cells with the lower priority.
Otherwise, the UE may perform the measurements of NR inter-frequency cells with the equal or lower priority, or the inter-RAT frequency cells with the lower priority.

In some implementations, if the UE supports the relaxed measurement and the relaxedMeasurement parameter is present in the SI (e.g., SIB2), the UE may further relax the needed measurements (e.g., as described in the TS 38.304).

In some implementations, S_{IntraSearchP} and S_{nonIntraSearchP} may be two parameters signaled by the network through the SI (e.g., SIB2). The parameters may be configured by the network and may satisfy S_{IntraSearchP}>S_{nonIntraSearchP}. Accordingly, there may be three conditions (scenarios), which include a first condition corresponding to the serving cell's Srxlev>S_{IntraSearchP} (and >S_{nonIntraSearchP}), a second condition corresponding to the serving cell's Srxlev≤S_{IntraSearchP} and >S_{nonIntraSearchP}, and a third condition corresponding to the serving cell's Srxlev≤S_{nonIntraSearchP} (and <S_{IntraSearchP}).

In some implementations, S_{IntraSearchQ} and S_{nonIntraSearchQ} may be two parameters signaled by the network through the SI (e.g., SIB2). The parameters may be configured by the network and may satisfy S_{IntraSearchQ}>S_{nonIntraSearchQ}. Accordingly, there may be three conditions (scenarios), which include a first condition corresponding to the serving cell's Squal>S_{IntraSearchQ} (and >S_{nonIntraSearchQ}), a second condition corresponding to the serving cell's Squal≤S_{IntraSearchQ} and >S_{nonIntraSearchQ}, and a third condition corresponding to the serving cell's Squal<S_{nonIntraSearchQ} (and <S_{IntraSearchQ}).

Table 1 below illustrates the measurement requirements for intra-frequency, inter-frequency, and intra-frequency (to be complied by the UE) corresponding to various conditions.

TABLE 1

| | | Inter-frequency | Inter-frequency |
|---|---|---|---|
| | Intra- | measurement | measurement on |
| Con- | frequency | on higher-priority | same/lower-priority |
| dition | measurement | frequency(ies) | frequency(ies) |
| A | N/A | Search each | N/A |
| | | frequency | |
| | | every (60 * Nlayers) | |
| | | seconds; | |
| | | Measure | |
| | | SS-RSRP or | |
| | | SS-RSRQ at | |
| | | least every | |
| | | T_{measure, NR}_Inter | |
| | | on each | |
| | | found cell | |
| B | Measure | Same as the | N/A |
| | SS-RSRP and | above grid | |
| | SS-RSRQ | | |
| | at least every | | |
| | T_{measure, NR}_Intra | | |
| C | Same as the | Search each | Search each |
| | above grid | frequency | frequency |
| | | every (K_{carrier} * | every (K_{carrier} * |
| | | T_{detect,} _{NR}_Inter) | T_{detect, NR}_Inter) |
| | | seconds; | seconds; |
| | | Measure | Measure |
| | | SS-RSRP or | SS-RSRP or |
| | | SS-RSRQ at | SS-RSRQ |
| | | least every | at least every |
| | | T_{measure, NR}_Inter | K_{carrier} * |
| | | on each | T_{measure, NR}_Inter |
| | | found cell | on each found cell |

In Table 1, Nlayers is the total number of (configured) higher-priority frequencies listed/broadcast in the SI. K_{carrier} is the total number of (configured) inter-frequencies listed/broadcast in the SI. Three conditions (e.g., conditions A, B, and C) may be determined based on the relation/comparison among serving cell's Srxlev/Squal, the parameter S_{IntraSearchP/Q}, and the parameter S_{nonIntraSearchP/Q}. The conditions A, B, and C may correspond to the requirements listed in row A, B, and C, respectively. The UE may comply with the requirements listed in row A, B, or C depending on whether the UE is (currently) in the condition A, B, or C, respectively. For example, if serving cell's Srxlev>S_{IntraSearchP} and Squal>S_{IntraSearchQ} (i.e., the UE is in the condition A), the UE may perform the inter-frequency/inter-RAT measurement (once) on each higher-priority frequency listed in the SI every 60*Nlayers seconds, and the UE may not (need to) perform the measurement on intra-frequency and inter-frequency/inter-RAT on the same-/lower-priority frequency(ies) listed in the SI.

Table 2 below illustrates a measurement period (T_{measure,NR_Intra}), detection period (T_{detect,NR_Intra}), and evaluation period (T_{evaluate,NR_Intra}) for intra-frequency cells.

TABLE 2

| DRX | | | T_{detect,NR}_Intra [s] | T_{measure,NR}_Intra | T_{evaluate,NR}_Intra |
|---|---|---|---|---|---|
| cycle | Scaling Factor (N1) | | (number of DRX | [s] (number of | [s] (number of |
| length [s] | FR1 | FR2^{Note1} | cycles) | DRX cycles) | DRX cycles) |
| 0.32 | 1 | 8 | 11.52 × N1 × M2 | 1.28 × N1 × M2 | 5.12 × N1 × M2 |
| | | | (36 × N1 × M2) | (4 × N1 × M2) | (16 × N1 × M2) |
| 0.64 | | 5 | 17.92 × N1 | 1.28 × N1 | 5.12 × N1 |
| | | | (28 × N1) | (2 × N1) | (8 × N1) |
| 1.28 | | 4 | 32 × N1 | 1.28 × N1 | 6.4 × N1 |
| | | | (25 × N1) | (1 × N1) | (5 × N1) |
| 2.56 | | 3 | 58.88 × N1 | 2.56 × N1 | 7.68 × N1 |
| | | | (23 × N1) | (1 × N1) | (3 × N1) |

^{Note 1}Applies for UE supporting power class 2&3&4. For UE supporting power class 1, N1 = 8 for all DRX cycle length.
Note 2:
M2 = 1.5 if SMTC periodicity of measured intra-frequency cell >20 ms; otherwise M2 = 1. If different SMTC periodicities are configured for different cells, the SMTC periodicity in this note is the one used by the cell being identified. During PSS/SSS detection, the periodicity of the SMTC configured for the intra-frequency carrier is assumed, and if the actual SSB transmission periodicity is greater than the SMTC configured for the intra-frequency carrier, longer T_{detect, NR}_Intra is expected.

In Table 2, T_{measure,NR_Intra} is the variable in units of second (e.g., as described in the TS 38.133). The value depends on UE's DRX cycle length and on which frequency range (e.g., FR1, FR2) the serving cell operates.

The UE may measure the SS-RSRP and SS-RSRQ at least every T_{measure,NR_Intra} for the intra-frequency cells that are identified and measured according to the measurement rules.

Table 3 below illustrates a measurement period (T_{measure,NR_Inter}), detection period (T_{detect,NR_Inter}), and evaluation period (T_{evaluate,NR_Inter}) for inter-frequency cells.

TABLE 3

| DRX | | | T_{detect,NR}_Inter [s] | T_{measure,NR}_Inter | T_{evaluate,NR}_Inter |
|---|---|---|---|---|---|
| cycle | Scaling Factor (N1) | | (number of DRX | [s] (number of | [s] (number of |
| length [s] | FR1 | FR2^{Note1} | cycles) | DRX cycles) | DRX cycles) |
| 0.32 | 1 | 8 | 11.52 × N1 × 1.5 | 1.28 × N1 × 1.5 | 5.12 × N1 × 1.5 |
| | | | (36 × N1 × 1.5) | (4 × N1 × 1.5) | (16 × N1 × 1.5) |
| 0.64 | | 5 | 17.92 × N1 | 1.28 × N1 | 5.12 × N1 |
| | | | (28 × N1) | (2 × N1) | (8 × N1) |
| 1.28 | | 4 | 32 × N1 | 1.28 × N1 | 6.4 × N1 |
| | | | (25 × N1) | (1 × N1) | (5 × N1) |
| 2.56 | | 3 | 58.88 × N1 | 2.56 × N1 | 7.68 × N1 |
| | | | (23 × N1) | (1 × N1) | (3 × N1) |

^{Note 1}Applies for UE supporting power class 2&3&4. For UE supporting power class 1, N1 = 8 for all DRX cycle length.

In Table 3, T_{measure, NR_Inter} is the variable in units of second (e.g., as described in the TS 38.133). The value depends on UE's DRX cycle length and on which frequency range (e.g., FR1, FR2) the serving cell operates.

The UE may measure the SS-RSRP and SS-RSRQ at least every T_{measure, NR_Inter} for the inter-frequency cells that are identified and measured according to the measurement rules.

Criteria for the relaxed measurements in the RRC_IDLE and RRC_INACTIVE states may be as follows.

In some implementations, in order to avoid unnecessary measurement (e.g., to reduce the UE's power consumption), various criteria may be used for (allowing) the UE to relax the measurement requirements when the UE fulfills either one of the criteria (e.g., as described in the TS 38.304). The criteria may include, but is not limited to, a low-mobility criterion and a not-at-cell-edge criterion.

In some implementations, the low-mobility criterion may be fulfilled when:
The UE is configured (only) with lowMobilityEvalutation.
The UE is configured with both lowMobilityEvalutation and cellEdgeEvaluation, but combineRelaxedMeasCondition is not configured.
The relaxed measurement criterion for the UE with low mobility is fulfilled. For example, (Srxlev_{Ref}−Srxlev)<S_{SearchDeltaP}, for at least T_{SearchDeltaP}, where Srxlev_{Ref}=reference Srxlev value of the serving cell (dB). Srxlev_{Ref} may be set to the current Srxlev value of the serving cell when at least one of a condition that after (re)selecting a new cell, a condition that if (Srxlev−Srxlev_{Ref})>0, or a condition that if the relaxed measurement criterion has not been met for T_{SearchDeltaP} is fulfilled.
An indicator indicates that a measurement for a high-priority frequency is relaxed (e.g., highPriorityMeasRelax=true) (e.g., under the conditions A and/or B illustrated in Table 1).

In some implementations, if at least one of the above low-mobility criteria is fulfilled, the UE may (determine to) relax the measurement requirements with the updated/relaxed requirements, as illustrated in Table 4.

Table 4 below illustrates the relaxed measurement requirements when the low-mobility criterion is fulfilled.

TABLE 4

| | | Inter-frequency | Inter-frequency |
|---|---|---|---|
| | | measurement | measurement on |
| Con- | Intra-frequency | on higher-priority | same/lower-priority |
| dition | measurement | frequency(ies) | frequency(ies) |
| A | N/A | Search each frequency | N/A |
| | | every 60 * (60 * | |
| | | Nlayers) seconds; | |
| | | Measure SS-RSRP or | |
| | | SS-RSRQ at | |
| | | least every | |
| | | T_{measure, NR}_Inter on | |
| | | each found cell | |
| B | Measure | Same as the | N/A |
| | SS-RSRP and | above grid | |
| | SS-RSRQ at | | |
| | least every | | |
| | 3 * T_{measure, NR}_Intra | | |
| C | Same as the | Search each frequency | Search each frequency |
| | above grid | every 3 * (K_{carrier} * | every 3 * (K_{carrier} * |
| | | T_{detect, NR}_Inter) | T_{detect, NR}_Inter) |
| | | seconds; | seconds; |
| | | Measure SS-RSRP or | Measure SS-RSRP or |
| | | SS-RSRQ at | SS-RSRQ at least every |
| | | least every | 3 * K_{carrier} * |
| | | 3 * T_{measure, NR}_Inter on | T_{measure, NR}_Inter |
| | | each found cell | on each found |
| | | | cell |

In some implementations, the not-at-cell-edge criterion may be fulfilled when:
The UE is configured (only) with cellEdgeEvaluation.
The UE is configured with both lowMobilityEvalutation and cellEdgeEvaluation, but combineRelaxedMeasCondition is not configured.
The relaxed measurement criterion for the UE not-at-cell-edge is fulfilled, for example, when at least one of a condition that Srxlev>S_{SearchThresholdP}, or a condition that Squal>S_{SearchThresholdQ} (if S_{SearchThresholdQ} is configured) is fulfilled.

In some implementations, the network may configure (new) thresholds S_{SearchThresholdP} and S_{SearchThresholdQ} to the UE. S_{SearchThresholdP} and S_{SearchThresholdQ} may be broadcast in the SI. S_{SearchThresholdP} and S_{SearchThresholdQ} may (be configured to) be smaller than S_{nonIntraSearchP} and S_{nonIntraSearchQ}, respectively. Accordingly, S_{SearchThresholdP} and S_{SearchThresholdQ} may be smaller than S_{IntraSearchP} and S_{IntraSearchQ}, respectively.

In some implementations, if at least one of the above not-at-cell-edge criteria is fulfilled, the UE may (determine to) relax the measurement requirements with the updated/relaxed requirements, as illustrated in Table 5.

Table 5 below illustrates the relaxed measurement requirements when the not-at-cell-edge criterion is fulfilled.

TABLE 5

| | | Inter-frequency | Inter-frequency |
|---|---|---|---|
| | | measurement on | measurement on |
| Con- | Intra-frequency | higher-priority | same/lower-priority |
| dition | measurement | frequency(ies) | frequency(ies) |
| A | N/A | Search each | N/A |
| | | frequency every | |
| | | (60 * Nlayers) | |
| | | seconds; | |
| | | Measure | |
| | | SS-RSRP or | |
| | | SS-RSRQ at | |
| | | least every | |
| | | T_{measure, NR}_Inter | |
| | | on each | |
| | | found cell | |
| B | Measure | Same as the | N/A |
| | SS-RSRP and | above grid | |
| | SS-RSRQ | | |
| | at least every | | |
| | 3 * T_{measure, NR}_Intra | | |
| C | Same as the | Search each | Search each |
| | above grid | frequency | frequency |
| | | every 3 * (K_{carrier} * | every 3 * (K_{carrier} * |
| | | T_{detect, NR}_Inter) | T_{detect, NR}_Inter) |
| | | seconds; | seconds; |
| | | Measure | Measure |
| | | SS-RSRP or | SS-RSRP or |
| | | SS-RSRQ at | SS-RSRQ at least |
| | | least every 3 * | every 3 * |
| | | T_{measure, NR}_Inter On | K_{carrier} * |
| | | each found cell | T_{measure, NR}_Inter |
| | | | on each found |
| | | | cell |

In some implementations, if both of the low-mobility criterion and the not-at-cell-edge criterion are configured by the network and are fulfilled at the UE side, the UE may further relax the measurement requirements and perform the measurement (occasionally) based on the updated/relaxed requirements, as illustrated in Table 6.

Table 6 below illustrates relaxed measurement requirements when both the low-mobility criterion and the not-at-cell-edge criterion are fulfilled.

TABLE 6

| | | | Inter-frequency |
|---|---|---|---|
| | | Inter-frequency | measurement on |
| Con- | Intra-frequency | measurement on higher- | same/lower-priority |
| dition | measurement | priority frequency(ies) | frequency(ies) |
| A | N/A | Search each frequency | N/A |
| | | every 60 minutes | |
| B | Measure | Same as the above grid | N/A |
| | SS-RSRP and | | |
| | SS-RSRQ | | |
| | at least every | | |
| | 60 minutes | | |
| C | Same as the | Same as the above grid | Search each frequency |
| | above grid | | every 60 minutes |

### UE's Mobility State and Its Impact

In some implementations, a UE may be in one of the following states in terms of the UE's mobility (e.g., as described in the TS 38.304). The UE's mobility state may depend on the total number of cell (re)selections performed/executed by the UE during/in a specific time interval (e.g., T_{Crmax}). The specific time interval may be configured/broadcast by the network.
High-mobility: If the total number of cell (re)selections during the time duration/period T_{Crmax} is greater than a threshold (e.g., N_{CR_H}). N_{CR_H} is the constant value configured/broadcast by the network.
Medium-mobility: If the total number of cell (re)selections during the time duration/period T_{Crmax} is not greater than (or less than) N_{CR_H} but greater than (or not less than) another threshold N_{CR_M}. N_{CR_M} is another constant value configured/broadcast by the network.
Normal-mobility: If the total number of cell (re)selections during the time duration/period T_{Crmax} is not greater than N_{CR_M}.

In some implementations, if the UE is in the High-mobility or Medium-mobility, the UE may apply the speed-dependent scaling rules which impact how easily/fast the UE may leave the current serving cell and reselect/camp on another cell. In general, the higher mobility a UE has, the easier/faster the UE may leave the current serving cell and reselect/camp on the other cell. In some implementations, if the UE is in the High-mobility or Medium-mobility, the UE may subtract a value from Q_{hyst}, which makes Q_{hyst} smaller, and accordingly, makes the ranking of the serving cell smaller. In some implementations, if the UE is in the High-mobility or Medium-mobility, the UE may scale Treselection_{RAT} by a fraction, which makes Treselection_{RAT} smaller, and accordingly, makes the evaluation time shorter while determining whether a neighboring cell is ranked better/higher than the serving cell is (and therefore makes it easier for the UE to reselect that neighboring cell).

### UE's Mobility in NTN

In some implementations, an NTN may refer to network(s) or a segment of a network(s) using the RF resources onboarding a satellite (or UAS platform).

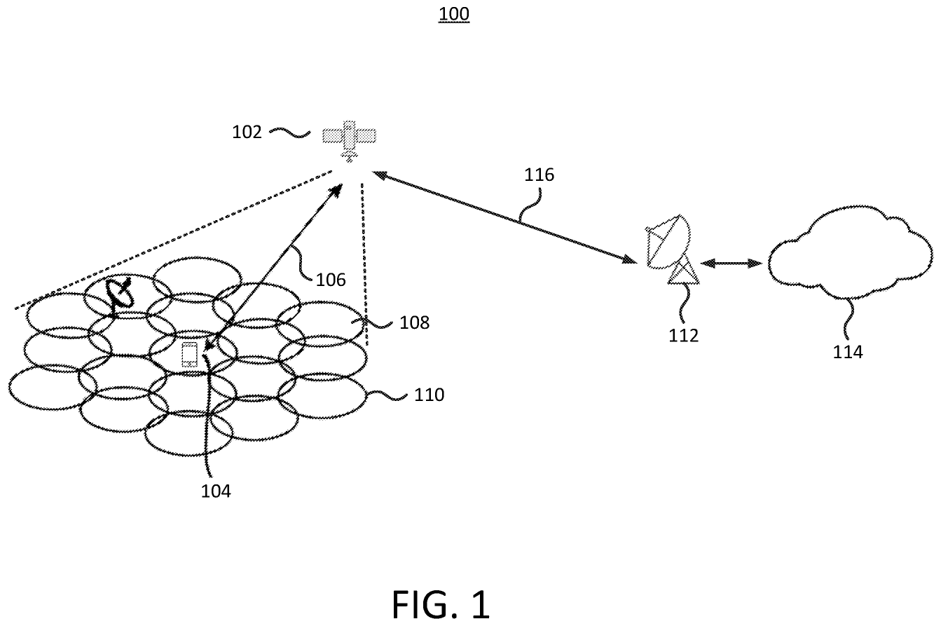

FIG. 1 is a diagram 100 illustrating wireless communication in an NTN (scenario), according to an example implementation of the present disclosure. As illustrated in FIG. 1, the NTN that provides access to at least one UE may include satellite (or UAS platform) 102, UE 104 (e.g., mobile device), service link 106, (beam) footprint 108, beam 110, (satellite) gateway 112, and feeder link 116. Specifically, satellite 102 may be connected to UE 104 via service link 106 and connected to gateway 112 via feeder link 116. Satellite 102 may be connected to (public) data network 114 via gateway 112.

The NTN may be based on a transparent payload (e.g., satellite 102 may implement the transparent payload). The NTN may provide access to at least one BS (e.g., gNB). UE 104 may be served by satellite 102 within a satellite targeted (service) coverage. Satellite 102 may refer to a GEO satellite that is fed by at least one gateway deployed across the satellite targeted coverage, or refer to a non-GEO (e.g., LEO, MEO, or UAS) satellite served successively by one or more satellite gateways at a time.

Satellite 102 may include a field of view (e.g., between the dashed lines shown in FIG. 1). The field of view (of satellite 102) may depend on an onboard antenna diagram and a minimum elevation angle. Satellite 102 may generate multiple beams (e.g., beams 110) (e.g., via an antenna onboard satellite 102) over a given (service) area (e.g., within the field of view). Footprints 108 of a beam may have an elliptic shape and overlap each other. Footprint 108 may be moving over the earth with satellite 102 moving over its orbit. Alternatively, footprint 108 may be earth fixed.

Various types of NTN platforms may be illustrated in Table 7 below, however, examples of NTN platforms may not be limited to the examples provided herein.

TABLE 7

| | | | Typical beam |
|---|---|---|---|
| Platforms | Altitude range | Orbit | footprint size |
| LEO satellite | 300-1,500 km | Circular around the | 100-1,000 km |
| MEO satellite | 7,000-25,000 km | earth | 100-1,000 km |
| GEO satellite | 35,786 km | notional station | 200-3,500 km |
| | | keeping position | |
| UAS platform | 8-50 km (20 km | fixed in terms of | 5-200 km |
| (including | for HAPS) | elevation/azimuth | |
| HAPS) | | with respect to a | |
| | | given earth point | |
| HEO satellite | 400-50,000 km | Elliptical around the | 200-3,500 km |
| | | earth | |

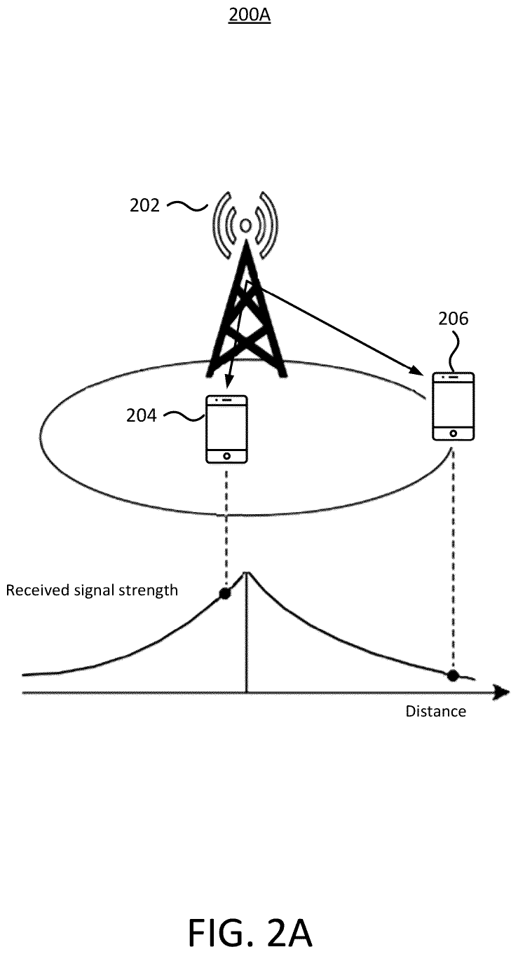

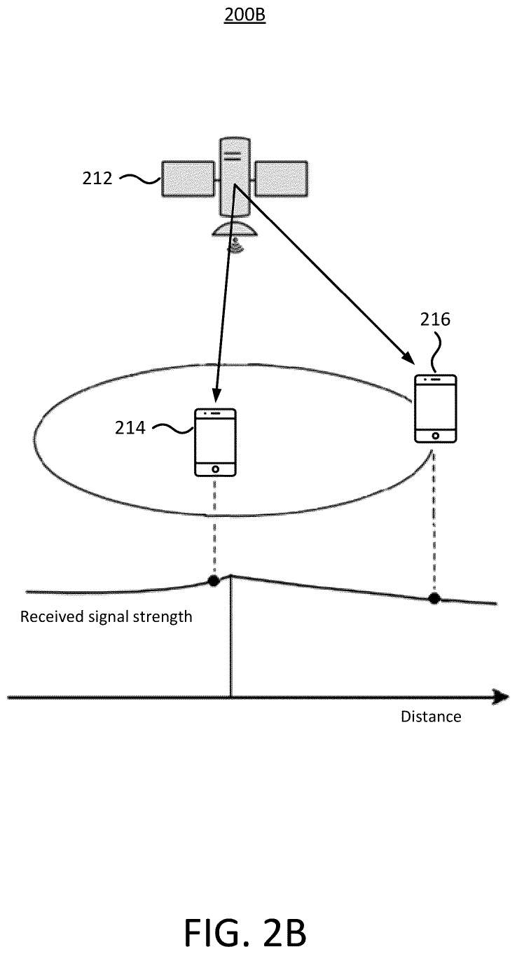

In some implementations, in terrestrial systems, a UE (e.g., an RRC_IDLE or RRC_INACTIVE UE) may determine that it is near a cell edge according to a clear difference in signal quality/strength/power (e.g., RSRP) as compared to the cell center. (e.g., as shown in FIG. 2A). Once there is a clear dropping in the RSRP while measuring the serving cell, the UE may trigger the measurement on the neighboring cells/frequencies (in order to camp on another cell in time). FIG. 2A is a diagram 200A illustrating a near-far effect in a TN scenario, according to an example implementation of the present disclosure. As illustrated in FIG. 2A, UE 204 and UE 206 are within the cell operated by BS (e.g., gNB) 202 and receive signals from BS 202. UE 204 is near the center of the cell and UE 206 is near the edge of the cell. The signal strength measured by UE 206 is far less than the signal strength measured by UE 204. As a result, UE 206 may trigger the measurement on the neighboring cells/frequencies.

However, such (dropping) effect may not be obvious in an NTN scenario/deployment (e.g., as shown in FIG. 2B), which may hinder the UE from measuring and (re)selecting the neighboring cells (even if the UE is at the cell edge) and may result in service discontinuity while moving across different cells. FIG. 2B is a diagram 200B illustrating a near-far effect in an NTN scenario, according to an example implementation of the present disclosure. As illustrated in FIG. 2B, UE 214 and UE 216 are within the cell operated by NTN BS (e.g., satellite) 212 and receive signals from NTN BS 212. UE 214 is near the center of the cell and UE 216 is near the edge of the cell. The signal strength measured by UE 216 is slightly less than the signal strength measured by UE 214. As a result, UE 216 may not trigger the measurement on the neighboring cells/frequencies.

To address the issue, location information and/or satellite ephemeris may be considered in addition to the measurement results while determining whether to trigger the measurement on the neighboring cells/frequencies.

In some implementations, in case that the UE is capable of connecting to either a TN cell or an NTN cell, it may be preferred that the UE prioritize the TN cell over the NTN cell at least for the cell reselection procedure. The benefits of prioritizing the TN cell over the NTN cell may include, at least, the UE being expected to have a higher data throughput and smaller data transmission delay while being served in the TN cell compared to being served in the NTN cell.

Table 8 illustrates the agreements regarding prioritizing a TN over an NTN.

TABLE 8
#Agreements in RAN2#114 e-meeting
For idle mode reselection, based on configuration NTN UE can prioritise
TN over NTN. Configuration details FFS
Same CHO trigger conditions and RRM events can be used within NTN
and NTN-TN mobility provided these are supported by the UE. NTN-TN
means both “from NTN to TN (hand-in)” and “from NTN to TN
(hand-in) and from TN to NTN (hand-out)”. FFS for enhancements.
#Agreements in RAN2#115 e-meeting
RAN2 continue discussing the exact solution for TN prioritization over
NTN for idle mode.

In some implementations, the network may indicate/configure the UE to prioritize TN over NTN (e.g., during the cell reselection procedure). For example, if the TN operates on the frequency range that is different from the frequency range of the NTN, the network may assign higher priorities to the TN frequencies listed in the SI (e.g., SIB4) (higher than the priorities assigned to the NTN frequencies). The UE may (be indicated/configured to) prioritize the search/measurement of the TN frequencies and camp on a TN cell (once) after the UE finds a suitable/qualified TN cell. In some implementations, instead of the network assigning an absolute priority to a specific frequency, the UE may automatically prioritize (e.g., give a higher priority to) a frequency if the UE detects a TN cell or an NTN cell (operating) on that frequency, which may depend on whether the UE is configured to prioritize the TN or the NTN. In some other implementations, the UE may automatically give a frequency low priority if the UE does not detect any TN/NTN cell (operating) on that frequency (carrier).

In some implementations, if the TN operates on the same frequency range as the NTN, the network may assign a cell-specific offset (e.g., q-OffsetCell) to a specific TN cell listed in the SI (e.g., SIB3) to elevate the ranking of that TN cell in order to increase the chance of the UE may camping on that cell. However, since there may be multiple TN cells deployed within the coverage of an NTN cell, broadcasting individually a cell-specific offset and the associated cell identity for each TN cell in the SI (e.g., SIB3) may result in significant signaling overheads. In this case, it may be beneficial to broadcast a common offset value in the SI (e.g., SIB3) (e.g., having a new IE without being associated to any cell in the SIB3) that is applicable to all the TN cells within the coverage of the NTN cell. In some implementations, the common offset value may be associated with a TN cell list. The TN cell list may be a list of cell identities. The network may provide one or more common offsets associated with one or more TN cells listed in the SI (e.g., SIB3 or any SIB). For example, a first common offset value V#1 may be associated with a first TN cell list TCL#1. A second common offset value V#2 may be associated with a second TN cell list, and so on.

Issues regarding handling a cell reselection procedure may be as follows.

To prioritize a TN cell in a cell reselection procedure, the UE camping on an NTN cell may keep measuring/detecting the neighboring TN cell(s) (if there is any). Usually, the UE may not (have to) measure the neighboring cell(s) if the signal strength/quality of the serving cell is above a given threshold (e.g., above S_{IntraSearchP}). It should be noted that in the NTN scenario, the small variation/attenuation of the signaling strength/quality/power observed in any location within the cell coverage may make it difficult to trigger the UE's measurement behavior and to find a suitable TN cell. The situation becomes complicated when the TN and NTN cells operate on the same frequency range.

The network may indicate/configure the UE to perform the measurement(s) on the TN frequency(ies) even if the signal strength/quality/power of the serving cell is above a given threshold (e.g., S_{nonIntraSearchP} or S_{nonIntraSearchQ}). For example, the TN frequencies may be configured with higher priorities (e.g., higher than the priority of the serving NTN frequency) when the TN and NTN operate on different frequency ranges. However, the measurement interval in such a scenario may at least 60-second long (could be more than 60 seconds if there are multiple higher-priority frequencies listed in the SI (e.g., SIB4)), which may be too long for the UE in the vicinity of a TN cell but may be too short for the UE far away from any TN deployment. It may be beneficial that the UE measures more frequently when the UE is in the vicinity of the TN cell and measures less frequently otherwise.

By obtaining geolocation information of each TN cell (e.g., the coordinate of the cell center, the radius of the cell, etc.) provided by the serving NTN cell, a GNSS-capable UE may (be able to) determine whether it is in the vicinity of the TN cell and may (be able to) apply different measurement patterns accordingly. However, since an NTN cell is typically much larger than a TN cell and thus there may be a huge number of TN cells overlapping/within the coverage of the NTN cell, the signaling overheads for broadcasting the geolocation information of each TN cell may be too large and thus may not be acceptable.

Implementations for handling the issues (e.g., in a case that TN cell(s) and NTN cell(s) operate on different frequency ranges) may be as follows.

In some implementations, the network may have (or be provided with) the knowledge regarding which frequency range(s) is operated by the NTN and which frequency range(s) is operated by the TN.

In some implementations, the network may broadcast in the SI (e.g., SIB4), or signal to the UE via dedicated RRC signaling (e.g., RRCRelease) the frequencies on which the TN cells operate. The network may assign to each TN frequency a priority value (e.g., via a cellReselectionPriority IE and optionally via cellReselectionSubPriority IEs), which may be higher/larger than the priority value of the serving frequency (e.g., indicated via the cellReselectionPriority IE and optionally via the cellReselectionSubPriority IE in SIB2).

In some implementations, the network may indicate for each frequency listed in the SI (e.g., SIB4) or in the dedicated RRC message whether the listed frequency is a TN frequency, an NTN frequency, or supports both TN and NTN.

In some implementations, if the UE is capable or configured to perform both TN and NTN communications, the UE may consider a frequency supporting (or providing) both T the N and NTN to be the highest priority. A frequency supporting TN may be prioritized over a frequency supporting NTN. If the UE is capable of or configured to communicate in a TN but not in an NTN, the UE may consider a frequency providing NTN to be the lowest priority and/or consider the frequency providing TN to be the highest priority. If the UE is capable or configured to perform NTN, but not TN, communication, the UE may consider the frequency providing NTN to be the highest priority and/or consider the frequency providing TN to be the lowest priority.

In some implementations, when an NTN UE camped in a normal state has (only) dedicated priorities other than for the current frequency, the UE may consider the current frequency to be the lowest priority frequency, if the current frequency supports the NTN cells. Otherwise, the current frequency (e.g., supporting TN cells) may have a higher priority than the frequency supporting NTN cells.

In some implementations, the network may configure and broadcast two threshold values, S_{IntraSearchP} and S_{nonIntraSearchP}, in the SI. In some implementations, the network may configure and broadcast another two threshold values, S_{IntraSearchQ} and S_{nonIntraSearchQ}. In some implementations, the two threshold values, S_{IntraSearchQ} and S_{nonIntraSearchQ}, may be broadcast in the SI (e.g., same as the two thresholds values, S_{IntraSearchQ} and S_{nonIntraSearchQ}). In some other implementations, the two threshold values, S_{IntraSearchQ} and S_{nonIntraSearchQ}, may be broadcast in another SI.

In some implementations, the network may broadcast in the SI or indicate via a dedicated RRC message an indication representing a density level of the TN deployment within an NTN cell. The indication may reflect two situations/states, such as {low, high}. The indication may reflect more than two situations/states, such as {level 0, level 1, . . . , level m}, where the higher-level number means the higher density.

In some implementations, after (or upon) receiving the SI for the cell reselection purpose (e.g., SIB2, SIB3, or SIB4), the UE may perform the measurement(s) on the higher-priority frequency(ies) according to the following rules.

In some implementations, if the Srxlev (of the serving cell)>S_{nonIntraSearchP} (and Squal>S_{nonIntraSearchQ} if S_{nonIntraSearchQ} is configured):
The UE may search for each higher-priority frequency every j*(60*Nlayer).
The UE may measure SS-RSRP and/or SS-RSRQ, at least every j*T_{measure, NR_Inter}, on each found cell on the higher-priority frequency.
j may be a state-dependent variable. The value of j may depend on the indication provided by the network regarding the density level of the TN deployment. For example, the mapping between the value of j and the density level may refer to a look-up table (e.g., such as Table 9).

Table 9 below illustrates an example mapping between a density level of the TN deployment and a value of j.

TABLE 9

| Density level of the TN deployment | Value of j |
|---|---|
| Level 0 | 10 |
| Level 1 | 5 |
| . . . | . . . |
| Level m | 0.2 |

As illustrated in Table 9, the higher the density is, the smaller the value of j.

In some implementations, if the Srxlev (of the serving cell)≤S_{nonIntraSearchP} (or Squal≤S_{nonIntraSearchQ}, if S_{nonIntraSearchQ} is configured):
The UE may search for each higher-priority frequency every k*(K_{carrier}*T_{detect, NR_Inter}).
The UE may measure SS-RSRP and/or SS-RSRQ, at least every k*T_{measure, NR_Inter}, on each found cell on the higher-priority frequency.
k may be a state-dependent variable. The value of k may depend on an indication provided by the network regarding the density level of the TN deployment. For example, the mapping between the value of k and the density level may refer to a look-up table (e.g., such as Table 10). In some implementations, the correspondence between the density level and the k value may be the same as the correspondence between the density level and the j value.

Table 10 below illustrates an example mapping between a density level of the TN deployment and a value of k.

TABLE 10

| Density level of the TN deployment | Value of k |
|---|---|
| Level 0 | 10 |
| Level 1 | 5 |
| . . . | . . . |
| Level m | 0.2 |

As illustrated in Table 10, the higher the density is, the smaller the value of k.

In some other implementations, the correspondence between the density level and the k value may be different from the correspondence between the density level and the j value.

In some implementations, the above rules may (only) be applied when the UE searches for/measures the TN frequencies/TN cells (instead of any higher-priority frequency). In some implementations, the above rules may (only) be applied when the UE searches for/measures the TN frequencies/TN cells (instead of any higher-priority frequency) under one or more conditions. For example, the above rules may (only) be applied when the UE searches for/measures the TN frequencies/TN cells (instead of any higher-priority frequency), if the network has indicated in the SI or in the dedicated RRC message whether a listed frequency is a TN or NTN frequency.

In some implementations, the lookup table for j value and/or the lookup table for k value may be configured/provided by the network in the SI or via the dedicated RRC message. If the lookup table for j value and/or the lookup table for k value is not provided by the network, the UE may use the default values/look-up tables (e.g., as described in the specifications).

In some implementations, if the Srxlev (of the serving cell)≤S_{nonIntraSearchP} (or Squal≤S_{nonIntraSearchQ}, if S_{nonIntraSearchQ} is configured):
The NTN UE may measure SS-RSRP and/or SS-RSRQ at least every K_{carrier_NTN}*T_{measure, NR_Inter} for identified lower or equal priority inter-frequency cells, if K_{carrier_NTN} is provided.
K_{carrier_NTN} may be defined as the density level of the NTN deployment associated with at least one of the density level of coverage holes, cell size, Earth-moving or Earth-fixed cells.

Implementations for handling the issues (e.g., in a case that the TN cell(s) and NTN cell(s) operate on the same frequency range) may be as follows.

In some implementations, the network may have the knowledge (or be provided with the knowledge) regarding which cell(s) is the NTN cell(s) and which cell(s) is the TN cell(s).

In some implementations, the network may broadcast in the SI (e.g., SIB3) a common offset value that is to be applied to any detected TN cells when evaluating the cell ranking for cell reselection purposes. The network may indicate in the cell list (e.g., IntraFreqNeighCellList in SIB3) whether a listed cell is a TN or an NTN cell.

In some implementations, the network may broadcast in the SI (e.g., SIB3) a cell-specific offset value for each TN cell listed in the cell list (e.g., IntraFreqNeighCellList in SIB3), which is to be applied when evaluating the cell ranking.

In some implementations, the network may configure and broadcast two threshold values, S_{IntraSearchP} and S_{nonIntraSearchP}, in the SI. In some implementations, the network may configure and broadcast another two threshold values, S_{IntraSearchQ} and S_{nonIntraSearchQ}. In some implementations, the two threshold values, S_{IntraSearchQ} and S_{nonIntraSearchQ}, may be broadcast in the SI (e.g., same as the two thresholds values, S_{IntraSearchQ} and S_{nonIntraSearchQ}). In some other implementations, the two threshold values, S_{IntraSearchQ} and S_{nonIntraSearchQ}, may be broadcast in another SI.

In some implementations, the network may broadcast in the SI or indicate via a dedicated RRC message an indication representing a density level of the TN deployment within an NTN cell. The indication may reflect two situations/states, such as {low, high}. The indication may reflect more than two situations/states, such as {level 0, level 1, . . . , level m}, where the higher-level number means the higher density.

In some other implementations, if the network has indicated in the cell list (e.g., IntraFreqNeighCellList in SIB3) whether a listed cell is a TN or an NTN cell, the UE may determine/calculate the density level of the TN deployment autonomously. For example, the UE may consider the density level of the TN deployment as high if the total number of TN cells listed in the SI exceeds a threshold value (e.g., N_{HighDensity}). The threshold value may be configured and broadcast by the network. Otherwise, the UE may consider the density level of the TN deployment as low. In the case where the UE needs to select one level among m density levels, the network may (need to) configure and broadcast m−1 threshold values in the SI. In some implementations, the threshold value may be predefined.

In some implementations, after (or upon) receiving the SI for the cell reselection purpose (e.g., SIB2, SIB3, or SIB4), the UE may perform the measurement(s) on the serving frequency according to the following rules.

In some implementations, if the Srxlev (of the serving cell)>S_{IntraSearchP} (and Squal>S_{IntraSearchQ} if S_{IntraSearchQ} is configured):
The UE may search the serving frequency every j*T_{detect, NR_Intra}.
The UE may measure SS-RSRP and/or SS-RSRQ, at least every j*T_{measure, NR_Intra}, on each found cell on the serving frequency. For example, the UE may measure the SS-RSRP and/or SS-RSRQ, at least every j*T_{measure, NR_Intra}, on each found TN cell on the serving frequency.
j may be a state-dependent variable. The value of j may depend on the indication provided by the network regarding the density level of the TN deployment. For example, the mapping between the value of j and the density level may refer to a look-up table (e.g., such as Table 11).

Table 11 below illustrates an example mapping between a density level of the TN deployment and a value of j.

TABLE 11

| Density level of the TN deployment | Value of j |
|---|---|
| Level 0 | Infinite |
| Level 1 | 10 |
| . . . | . . . |
| Level m | 1 |

As illustrated in Table 11, the higher the density is, the smaller the value of j.

In some implementations, if the Srxlev (of the serving cell)≤S_{IntraSearchP} (or Squal≤S_{IntraSearchQ} if S_{IntraSearchQ} is configured):
The UE may search the serving frequency every k*T_{detect, NR_Intra}.
The UE may measure SS-RSRP and/or SS-RSRQ, at least every k*T_{measure, NR_Intra}, on each found cell on the serving frequency. For example, the UE may measure the SS-RSRP and/or SS-RSRQ, at least every k*T_{measure, NR_Intra}, on each found TN cell on the serving frequency.
k may be a state-dependent variable. The value of k may depend on the indication provided by the network regarding the density level of the TN deployment. k may be a fraction not larger than one. For example, the mapping between the value of k and the density level may refer to a look-up table (e.g., such as Table 12)

Table 12 below illustrates an example mapping between a density level of the TN deployment and a value of k.

TABLE 12

| Density level of the TN deployment | Value of k |
|---|---|
| Level 0 | 1 |
| Level 1 | 0.9 |
| . . . | . . . |
| Level m | 0.1 |

As illustrated in Table 12, the higher the density, the smaller the value of k is.

In some implementations, the lookup table for j value and/or the lookup table for k value may be configured/provided by the network in the SI or via the dedicated RRC message. If the lookup table for j value and/or the lookup table for k value is not provided by the network, the UE may use the default values/look-up tables (e.g., as described in the specifications).

Implementations for handling the issues (e.g., in a case that TN cell(s) and NTN cell(s) operate on different frequency ranges) may be as follows.

In some implementations, the network may have (or be provided with) the knowledge regarding which frequency range(s) is operated by the NTN and which frequency range(s) is operated by the TN.

In some implementations, the network may broadcast in the SI (e.g., SIB4), or signal to the UE via dedicated RRC signaling (e.g., RRCRelease) frequencies on which the TN cells operate. The network may assign to each TN frequency a priority value (e.g., via a cellReselectionPriority IE and optionally via cellReselectionSubPriority IEs), which may be higher/larger than the priority value of the serving frequency (e.g., indicated via the cellReselectionPriority IE and optionally via the cellReselectionSubPriority IE in SIB2).

In some implementations, the network may indicate for each frequency listed in the SI (e.g., SIB4) or in the dedicated RRC message whether the listed frequency is a TN frequency, an NTN frequency, or supports both the TN and NTN.

In some implementations, if the UE is capable or configured to perform both the TN and NTN communication, the UE may consider a frequency supporting (or providing) both the TN and NTN to be the highest priority. A frequency supporting TN may be prioritized over a frequency supporting NTN. If the UE is capable or configured to perform TN, but not NTN, communication, the UE may consider a frequency providing NTN to be the lowest priority and/or consider the frequency providing TN to be the highest priority. If the UE is capable or configured to perform NTN, but not TN, communication, the UE may consider the frequency providing NTN to be the highest priority and/or consider the frequency providing TN to be the lowest priority.

In some implementations, when an NTN UE camped in a normal state has (only) dedicated priorities other than for the current frequency, the UE may consider the current frequency to be the lowest priority frequency, if the current frequency supports NTN cells. Otherwise, the current frequency (e.g., supporting TN cells) may have higher priority than the frequency supporting NTN cells.

In some implementations, the network may configure and broadcast two threshold values, S_{IntraSearchP} and S_{nonIntraSearchP}, in the SI. In some implementations, the network may configure and broadcast another two threshold values, S_{IntraSearchQ} and S_{nonIntraSearchQ}. In some implementations, the two threshold values, S_{IntraSearchQ} and S_{nonIntraSearchQ}, may be broadcast in the SI (e.g., same as the two thresholds values, S_{IntraSearchQ} and S_{nonIntraSearchQ}). In some other implementations, the two threshold values, S_{IntraSearchQ} and S_{nonIntraSearchQ}, may be broadcast in another SI.

In some implementations, the network may broadcast in the SI or indicate via a dedicated RRC message one or more area information of specific area(s), where the TN cell(s) is deployed within the specific area(s). The area information may provide the UE with the information regarding the center location of the area, the shape of the area, the boundary(ies) of the area, and/or the size of the area. In some implementations, the area information may include the area's central coordinates and the radius of the area (e.g., the area in this case is a circular area). In some implementations, the area information may not include any cell identity since the area may be spanned by the coverage of multiple cells.

In some implementations, when more than one area information is provided to the UE, each of the area information may be associated with a particular TN frequency listed in the frequency list. In some other implementations, when more than one area information is provided to the UE, there may be no association between the area information provided to UE and the TN frequency listed in the frequency list (e.g., the area information may not reveal any frequency related information).

In some implementations, when the area information is provided, the UE may assume the area information to be valid and applicable if the UE location information (e.g., acquired from a GNSS receiver at the UE side) is valid. It should be noted that the UE may maintain the valid GNSS information in the RRC_CONNECTED state, and its validity may last for a period after the UE leaves the RRC_CONNECTED state. The UE may not (be allowed to) maintain the GNSS (information) in the RRC_IDLE state except for the initial access.

In some implementations, after (or upon) receiving the SI for the cell reselection purpose (e.g., SIB2, SIB3, or SIB4), the UE may perform the measurement(s) on the higher-priority frequency(ies) according to the following rules.

In some implementations, if the Srxlev (of the serving cell)>S_{nonIntraSearchP} (and Squal>S_{nonIntraSearchQ} if S_{nonIntraSearchQ} is configured):
The UE may search for each higher-priority frequency every j*(60*Nlayer).
The UE may measure SS-RSRP and/or SS-RSRQ, at least every j*T_{measure, NR_Inter}, on each found cell on the higher-priority frequency.
j may be a state-dependent variable. The value of j may depend on whether the UE is within any area indicated by the one or more area information provided to the UE. In some implementations, if the UE is within the area indicated by the area information, j may equal 0.5; otherwise, j may equal 2.

In some implementations, if the Srxlev (of the serving cell)≤S_{nonIntraSearchP} (or Squal≤S_{nonIntraSearchQ}, if S_{nonIntraSearchQ} is configured):
The UE may search for each higher-priority frequency every k*(K_{carrier}*T_{detect, NR_Inter}).
The UE may measure SS-RSRP and/or SS-RSRQ, at least every k*T_{measure, NR_Inter}, on each found cell on the higher-priority frequency.
k may be a state-dependent variable. The value of k may depend on whether the UE is within any area indicated by the one or more area information provided to the UE. In some implementations, if the UE is within the area indicated by the area information, k may equal 0.5; otherwise, k may equal 1.

In some implementations, the above rules may (only) be applied when the UE searches for/measures the TN frequencies/TN cells (instead of (all) higher-priority frequencies). In some implementations, the above rules may (only) be applied when the UE searches for/measures the TN frequencies/TN cells (instead of any higher-priority frequency) under one or more conditions. For example, the above rules may (only) be applied when the UE searches for/measures the TN frequencies/TN cells (instead of any higher-priority frequency), if the network has indicated in the SI or in the dedicated RRC message whether a listed frequency is a TN or NTN frequency.

In some implementations, the values of j and/or the values of k may be configured/provided by the network in the SI or via the dedicated RRC message. If the values of j and/or the values of k are not provided by the network, the UE may use the default values (e.g., as described in the specifications).

Implementations for handling the issues (e.g., in a case that TN cell(s) and NTN cell(s) operate on the same frequency range) may be as follows.

In some implementations, the network may have the knowledge (or be provided with the knowledge) regarding which cell(s) is a NTN cell(s) and which cell(s) is a TN cell(s).

In some implementations, the network may broadcast in the SI (e.g., SIB3) a common offset value that is to be applied to any detected TN cells when evaluating the cell ranking for the cell reselection purposes. The network may indicate in the cell list (e.g., IntraFreqNeighCellList in SIB3) whether a listed cell is a TN or NTN cell.

In some implementations, the network may broadcast in the SI (e.g., SIB3) a cell-specific offset value for each TN cell listed in the cell list (e.g., IntraFreqNeighCellList in SIB3), which is to be applied when evaluating the cell ranking.

In some implementations, the network may configure and broadcast two threshold values, S_{IntraSearchP} and S_{nonIntraSearchP}, in the SI. In some implementations, the network may configure and broadcast another two threshold values, S_{IntraSearchQ} and S_{nonIntraSearchQ}. In some implementations, the two threshold values, S_{IntraSearchQ} and S_{nonIntraSearchQ}, may be broadcast in the SI (e.g., same as the two thresholds values, S_{IntraSearchQ} and S_{nonIntraSearchQ}). In some other implementations, the two threshold values, S_{IntraSearchQ} and S_{nonIntraSearchQ}, may be broadcast in another SI.

In some implementations, the network may broadcast in the SI or indicate via a dedicated RRC message one or more area information of specific area(s), where the TN cell(s) is deployed within the specific area(s). The area information may provide the UE with the information regarding the center location of the area, the shape of the area, the boundary(ies) of the area, and/or the size of the area. In some implementations, the area information may include the area's central coordinates and the radius of the area (e.g., when the area a circular). In some implementations, the area information may not include any cell identity since the area may be spanned by the coverage of multiple cells.

In some implementations, when more than one area information is provided to the UE, each of the area information may be associated with a particular TN frequency listed in the frequency list. In some other implementations, when more than one area information is provided to the UE, there may be no association between the area information provided to UE and the TN frequency listed in the frequency list (e.g., the area information may not reveal any frequency related information).

In some implementations, when the area information is provided, the UE may assume the area information to be valid and applicable if the UE location information (e.g., acquired from a GNSS receiver at the UE side) is valid. It should be noted that the UE may maintain the valid GNSS information in the RRC_CONNECTED state, and its validity may last for a period after the UE leaves the RRC_CONNECTED state. The UE may not (be allowed to) maintain the GNSS (information) in the RRC_IDLE state except for the initial access.

In some implementations, after (or upon) receiving the SI for the cell reselection purpose (e.g., SIB2, SIB3, or SIB4), the UE may perform the measurement(s) on the serving frequency according to the following rules.

In some implementations, if the Srxlev (of the serving cell)>S_{IntraSearchP} (and Squal>S_{IntraSearchQ} if S_{IntraSearchQ} is configured):
The UE may search the serving frequency every j*T_{detect, NR_Intra}.
The UE may measure SS-RSRP and/or SS-RSRQ, at least every j*T_{measure, NR_Intra}, on each found cell on the serving frequency. For example, the UE may measure SS-RSRP and/or SS-RSRQ, at least every j*T_{measure, NR_Intra}, on each found TN cell on the serving frequency.
j may be a state-dependent variable. The value of j may depend on whether the UE is within any area indicated by the one or more area information provided to the UE. In some implementations, if the UE is within the area indicated by the area information, j may equal 1; otherwise, j may equal infinite.

In some implementations, if the Srxlev (of the serving cell)≤S_{IntraSearchP} (or Squal≤S_{IntraSearchQ} if S_{IntraSearchQ} is configured):
The UE may search the serving frequency every k*T_{detect, NR_Intra}.
The UE may measure SS-RSRP and/or SS-RSRQ, at least every k*T_{measure, NR_Intra}, on each found cell on the serving frequency. For example, the UE may measure SS-RSRP and/or SS-RSRQ, at least every k*T_{measure, NR_Intra}, on each found TN cell on the serving frequency.
k may be a state-dependent variable. The value of k may depend on whether the UE is within any area indicated by the one or more area information provided to the UE. In some implementations, if the UE is within the area indicated by the area information, k may equal 0.5; otherwise, k may equal 1.

In some implementations, the values of j and/or the values of k may be configured/provided by the network in the SI or via the dedicated RRC message. If the values of j and/or the values of k are not provided by the network, the UE may use the default values (e.g., as described in the specifications).

Implementations for handling the issues (e.g., in a case that TN cell(s) and NTN cell(s) operate on different frequency ranges) may be as follows.

In some implementations, the network may have (or be provided with) the knowledge regarding which frequency range(s) is operated by the NTN and which frequency range(s) is operated by the TN.

In some implementations, the network may broadcast in the SI (e.g., SIB4), or signal to the UE via dedicated RRC signaling (e.g., RRCRelease) frequencies on which the TN cells operate. The network may assign to each TN frequency a priority value (e.g., via a cellReselectionPriority IE and optionally via cellReselectionSubPriority IEs), which may be higher/larger than the priority value of the serving frequency (e.g., indicated via the cellReselectionPriority IE and optionally via the cellReselectionSubPriority IE in SIB2).

In some implementations, the network may indicate for each frequency listed in the SI (e.g., SIB4) or in the dedicated RRC message whether the listed frequency is a TN frequency, an NTN frequency, or supports both the TN and NTN.

In some implementations, if the UE is capable or configured to perform both the TN and NTN communication, the UE may consider a frequency supporting (or providing) both the TN and NTN to be the highest priority. A frequency supporting TN may be prioritized over a frequency supporting NTN. If the UE is capable or configured to perform TN, but not NTN, communication, the UE may consider a frequency providing NTN to be the lowest priority and/or consider the frequency providing TN to be the highest priority. If the UE is capable or configured to perform NTN but not TN communication, the UE may consider the frequency providing NTN to be the highest priority and/or consider the frequency providing TN to be the lowest priority.

In some implementations, when an NTN UE camped in a normal state has (only) dedicated priorities other than for the current frequency, the UE may consider the current frequency to be the lowest priority frequency, if the current frequency supports the NTN cells. Otherwise, the current frequency (e.g., supporting the TN cells) may have higher priority than the frequency supporting NTN cells.

In some implementations, the network may configure and broadcast two threshold values, S_{IntraSearchP} and S_{nonIntraSearchP}, in the SI. In some implementations, the network may configure and broadcast another two threshold values, S_{IntraSearchQ} and S_{nonIntraSearchQ}. In some implementations, the two threshold values, S_{IntraSearchQ} and S_{nonIntraSearchQ}, may be broadcast in the SI (e.g., same as the two thresholds values, S_{IntraSearchQ} and S_{nonIntraSearchQ}). In some other implementations, the two threshold values, S_{IntraSearchQ} and S_{nonIntraSearchQ}, may be broadcast in another SI.

In some implementations, the network may broadcast in the SI (e.g., SIB4) and/or signal to the UE via dedicated RRC signaling (e.g., RRCRelease) a timer value (e.g., T_{Relax-TN}). T_{Relax-TN} may have a reference value predefined/described in the specifications. If T_{Relax-TN} is provided via the dedicated RRC message, the UE may overwrite the T_{Relax-TN} obtained from the SI or overwrite the predefined T_{Relax-TN} described in the specifications. If T_{Relax-TN} is provided via the SI, the UE may overwrite the predefined T_{Relax-TN} described in the specifications.

In some implementations, the UE may start/restart the T_{Relax-TN} when (or upon) entering into an RRC_INACTIVE/IDLE state, or when (or upon) camping on a new cell.

In some implementations, the UE may restart the T_{Relax-TN} when detecting any cell while searching for the higher-priority frequencies. In some other implementations, the UE may restart the T_{Relax-TN} when the UE detects any cell while searching for the TN frequencies (if the network has indicated in the SI whether a listed frequency is a TN or NTN frequency).

In some implementations, the UE may stop the T_{Relax-TN} after (or upon) being instructed by the network (e.g., through sending and/or toggling a flag/IE in the SI).

In some implementations, the UE may multiply the T_{Relax-TN} by a factor (e.g., the S_{Trelax}). The factor may depend on UE's mobility state estimated. In some implementations, the higher mobility state may result in a larger factor value.

In some implementations, the UE may stop the T_{Relax-TN} a time duration/period (e.g., a few seconds) before the timing at which the serving cell is going to stop serving the area. The timing may be known to the UE via the SI.

In some implementations, the UE may stop the T_{Relax-TN} a distance (e.g., a few hundreds/thousand meters) before the UE is going to leave the serving area of the serving cell, if the UE is capable of GNSS reading and maintains valid GNSS information.

In some implementations, after (or upon) receiving the SI for the cell reselection purpose (e.g., SIB2, SIB3, or SIB4), the UE may perform the measurement(s) on the higher-priority frequency(ies) according to the following rules.

In some implementations, if the Srxlev (of the serving cell)>S_{nonIntraSearchP} (and Squal>S_{nonIntraSearchQ} if S_{nonIntraSearchQ} is configured):
The UE may search for each higher-priority frequency every j*(60*Nlayer).
The UE may measure the SS-RSRP and/or SS-RSRQ, at least every j*T_{measure, NR_Inter}, on each found cell on the higher-priority frequency.
j may be a state-dependent variable. The value of j may depend on whether the T_{Relax-TN} is running or not. In some implementations, if the T_{Relax-TN} is running, j may equal 0.5; otherwise,/may equal 2.

In some implementations, if the Srxlev (of the serving cell)≤S_{nonIntraSearchP} (or Squal≤S_{nonIntraSearchQ}, if S_{nonIntraSearchQ} is configured):
The UE may search for each higher-priority frequency every k*(K_{carrier}*T_{detect, NR_Inter}).
The UE may measure the SS-RSRP and/or SS-RSRQ, at least every k*T_{measure, NR_Inter}, on each found cell on the higher-priority frequency.
k may be a state-dependent variable. The value of k may depend on whether the T_{Relax-TN} is running or not. In some implementations, if the T_{Relax-TN} is running, k may equal 0.5; otherwise, k may equal 1.

In some implementations, the above rules may (only) be applied when the UE searches for/measures the TN frequencies/TN cells (instead of (all) higher-priority frequencies). In some implementations, the above rules may (only) be applied when the UE searches for/measures the TN frequencies/TN cells (instead of any higher-priority frequency) under one or more conditions. For example, the above rules may (only) be applied when the UE searches for/measures the TN frequencies/TN cells (instead of any higher-priority frequency), if the network has indicated in the SI or in the dedicated RRC message whether a listed frequency is a TN or NTN frequency.

In some implementations, the values of j and/or the values of k may be configured/provided by the network in the SI or via the dedicated RRC message. If the values of j and/or the values of k are not provided by the network, the UE may use the default values (e.g., as described in the specifications).

Implementations for handling the issues (e.g., in a case that TN cell(s) and NTN cell(s) operate on the same frequency range) may be as follows.

In some implementations, the network may have the knowledge (or be provided with the knowledge) on which cell(s) is NTN cell(s) and which cell(s) is TN cell(s).

In some implementations, the network may broadcast in the SI (e.g., SIB3) a common offset value that is to be applied to any detected TN cells when evaluating the cell ranking for cell reselection purposes. The network may indicate in the cell list (e.g., the IntraFreqNeighCellList in SIB3) whether a listed cell is a TN or NTN cell.

In some implementations, the network may broadcast in the SI (e.g., SIB3) a cell-specific offset value for each TN cell listed in the cell list (e.g., the IntraFreqNeighCellList in SIB3), which is to be applied when evaluating the cell ranking.

In some implementations, the network may configure and broadcast two threshold values, S_{IntraSearchP} and S_{nonIntraSearchP}, in the SI. In some implementations, the network may configure and broadcast another two threshold values, S_{IntraSearchQ} and S_{nonIntraSearchQ}. In some implementations, the two threshold values, S_{IntraSearchQ} and S_{nonIntraSearchQ}, may be broadcast in the SI (e.g., same as the two thresholds values, S_{IntraSearchQ} and S_{nonIntraSearchQ}). In some other implementations, the two threshold values, S_{IntraSearchQ} and S_{nonIntraSearchQ}, may be broadcast in another SI.

In some implementations, the network may broadcast in the SI (e.g., SIB4) and/or signal to the UE via dedicated RRC signaling (e.g., RRCRelease) a timer value (e.g., T_{Relax-TN}). The T_{Relax-TN} may have a reference value predefined/described in the specifications. If the T_{Relax-TN} is provided via the dedicated RRC message, the UE may overwrite the T_{Relax-TN} obtained from the SI or overwrite the predefined T_{Relax-TN} described in the specifications. If the T_{Relax-TN} is provided via the SI, the UE may overwrite the predefined T_{Relax-TN} described in the specifications.

In some implementations, the UE may start/restart the T_{Relax-TN} when (or upon) entering into the RRC_INACTIVE/IDLE state, or when (or upon) camping on a new cell.

In some implementations, the UE may restart the T_{Relax-TN} when detecting any cell while searching on the serving frequency.

In some implementations, the UE may stop the T_{Relax-TN} after (or upon) being instructed by the network (e.g., through sending and/or toggling a flag/IE in the SI).

In some implementations, the UE may multiply the T_{Relax-TN} by a factor (e.g., S_{Trelax}). The factor may depend on UE's mobility state estimated. In some implementations, the higher mobility state may result in a larger factor value.

In some implementations, the UE may stop the T_{Relax-TN} a time duration/period (e.g., a few seconds) before the timing at which the serving cell is going to stop serving the area. The timing may be known to the UE via the SI.

In some implementations, the UE may stop the T_{Relax-TN} a distance (e.g., a few hundreds/thousand meters) before the UE is going to leave the serving area of the serving cell, if the UE is capable of GNSS reading and maintains valid GNSS information.

In some implementations, after (or upon) receiving the SI for the cell reselection purpose (e.g., SIB2, SIB3, or SIB4), the UE may perform the measurement(s) on the serving frequency according to the following rules.

In some implementations, if the Srxlev (of the serving cell)>S_{IntraSearchP} (and Squal>S_{IntraSearchQ} if S_{IntraSearchQ} is configured):
The UE may search the serving frequency every j*T_{detect, NR_Intra}.
The UE may measure the SS-RSRP and/or SS-RSRQ, at least every j*T_{measure, NR_Intra}, on each found cell on the serving frequency. For example, the UE may measure the SS-RSRP and/or SS-RSRQ, at least every j*T_{measure, NR_Intra}, on each found TN cell on the serving frequency.
j may be a state-dependent variable. The value of j may depend on whether the T_{Relax-TN} is running or not. In some implementations, if the T_{Relax-TN} is running, j may equal 1; otherwise, j may equal 60.

In some implementations, if the Srxlev (of the serving cell)≤S_{IntraSearchP} (or Squal≤S_{IntraSearchQ} if S_{IntraSearchQ} is configured):
The UE may search the serving frequency every k*T_{detect, NR_Intra}.
The UE may measure the SS-RSRP and/or SS-RSRQ, at least every k*T_{measure, NR_Intra}, on each found cell on the serving frequency. For example, the UE may measure the SS-RSRP and/or SS-RSRQ, at least every k*T_{measure, NR_Intra}, on each found TN cell on the serving frequency.
k may be a state-dependent variable. The value of k may depend on whether the T_{Relax-TN} is running or not. In some implementations, if the T_{Relax-TN} is running, k may equal 0.5; otherwise, k may equal 1.

In some implementations, the values of j and/or the values of k may be configured/provided by the network in the SI or via the dedicated RRC message. If the values of j and/or the values of k is not provided by the network, the UE may use the default values (e.g., as described in the specifications).

In some implementations, the above implementations may be operated based on whether the UE is staying in the area of TN-only/NTN-only or supported by both TN and NTN.

In some other implementations, the above implementations may not be operated based on whether the UE is staying in the area of TN-only/NTN-only or supported by both TN and NTN.

Issues regarding handling a cell reselection procedure may be as follows.

The criteria for the relaxed measurement (e.g., low-mobility criterion, not-at-cell-edge criterion) may be used to reduce the UE's power consumption when the UE is almost stationary and/or is not located at the cell edge. However, the effect of the low-mobility criterion and/or the not-at-cell-edge criterion may be reduced in an NTN scenario (e.g. when the UE camps on an NTN cell), due to the small variation and slow attenuation of the signal strength observed by the UE from different locations on the earth. Specifically, the UE camping on the NTN cell may fulfill both the criteria easily and thus be allowed to relax the intra-frequency, inter-frequency, and inter-RAT measurement, which may hinder the UE from switching to a TN cell since it may take a long time for such the UE to find/detect the TN cell.

Implementations for handling the issues may be as follows.

In some implementations, when the UE camping on an NTN cell fulfills the low-mobility criterion, fulfills the not-at-cell-edge criterion, or fulfills both criteria, the UE may (be allowed to) perform the measurement based on the relaxed requirement (e.g., as illustrated in Table 4, Table 5, Table 6, respectively) only if at least one of the following conditions is also fulfilled (e.g., an additional condition is applied).
The UE is not within any area of a TN deployment. For example, the UE may determine whether it is within an area of the TN deployment based on its geolocation (and therefore the UE is a GNSS-capable UE) and area information (e.g., as described above) broadcast by the network (e.g. gNB).
The UE is configured with a timer T_{Relax-TN} (e.g., as described above), and the timer is not running (e.g., the timer has expired or been stopped).

In some implementations, the UE may report assistant information (e.g., via UEAssistanceinfo in UL control signaling) to the network to assist the network providing parameters for the UE to evaluate the low-mobility criterion, or the not-at-cell-edge criterion. The reporting may be configured by the network via a dedicated RRC message (e.g., RRCRelease) or in response to the network's request (e.g., via CN paging or RAN paging). The assistant information may be UE's preferred (or supported) configuration based on UE's mobility or capability. While being configured by the network, the UE may report the assistant information upon (the same timing of) performing RANU or TAU.

In some implementations, when the UE camping on an NTN cell fulfills the low-mobility criterion, fulfills the not-at-cell-edge criterion, or fulfills both criteria, the UE may (be allowed to) perform the measurement based on the relaxed requirement (as illustrated in Table 4, Table 5, Table 6, respectively).

In some implementations, the UE may determine whether it fulfills the low-mobility criterion based on the reading of its GNSS coordinate instead of based on the measurement on the signal strength.

In some implementations, the low-mobility criterion may be fulfilled if:
The UE is configured (only) with the lowMobilityEvalutation.
The UE is configured with both the lowMobilityEvalutation and the cellEdgeEvaluation, and the combineRelaxedMeasCondition is not configured.
The relaxed measurement criterion for the UE with low mobility is fulfilled. For example, |GNSS_Coordinate_{now}−GNSS_Coordinateₚᵣₑ|<D_{delta_T}, for at least T_{low_mobility}, where GNSS_Coordinate_{now} is the current reading of the UE's GNSS coordinate, GNSS_Coordinateₚᵣₑ is the previous reading of the UE's GNSS coordinate, D_{delta_T} is a distance threshold used by the UE to determine its mobility, T_{low_mobility} is a time threshold used by the UE to determine its mobility, and the interval between two contiguous GNSS readings is T_{GNSS_interval}. D_{delta_T}, T_{low_mobility}, and T_{GNSS_interval} may be provided to the UE, such as by broadcasting in the SI, signaling via a dedicated RRC message (e.g., RRCRelease), and a predefined/fixed value (e.g., as described in the 3GPP specifications).
An indicator indicates that a measurement for a high-priority frequency may be relaxed (e.g., highPriorityMeasRelax=true) (e.g., under the conditions A and/or B illustrated in Table 1).

In some implementations, the above implementations may be operated based on whether the UE is staying in the area of TN-only/NTN-only or supported by both TN and NTN.

In some other implementations, the above implementations may not be operated based on whether the UE is staying in the area of TN-only/NTN-only or supported by both TN and NTN.

Issues regarding handling a cell reselection procedure may be as follows.

The network may configure cell reselection behavior of the UE such that the UE prioritizes TN cell(s) over NTN cell(s). However, the UE may (or should) not prioritize the TN cell(s) under some specific situations and the situations may (only) be known to the UE. For example, when the UE moves fast (e.g., the UE has high mobility), it may be better for the UE to stay in an NTN cell instead of switching to a TN cell, since normally the NTN cell is much larger than the TN cell and accordingly staying in the NTN cell may prevent the UE from keeping switching its serving cell while moving. Therefore, it may be beneficial that the UE determines whether to prioritize the TN cell(s) based on the UE's mobility state. However, the current MSE scheme (e.g., as described in the 3GPP) is based on the total number of cell reselections that occurred within a given time interval, which may not reflect the UE's true mobility in the NTN scenario, as the total number of cell reselections in the NTN scenario are mostly contributed by the satellite's mobility rather than the UE's mobility.

Implementations for handling the issues may be as follows.

In some implementations, when the UE is configured by the network to prioritize the TN over the NTN in the cell reselection procedure, the UE may (determine to) not prioritize the TN if the UE is in specific mobility state(s) (e.g., the high-mobility state).

In some implementations, if TN and NTN operate on different frequency ranges and the network configures the TN frequencies with higher priorities in the SI, the UE may (determine to) apply a default priority (e.g., the same priority as the serving frequency) to the TN frequencies listed in the SI), if the UE is in specific mobility state(s) (e.g., the high-mobility state). In some implementations, the network may indicate whether a listed frequency is a TN frequency or NTN frequency in the SI.

In some implementations, if TN and NTN operate on the same frequency and the network configures the TN cell with a specific offset (e.g., a common offset for all TN cells or an individual offset) which makes the ranking of the TN cell configured with the specific offset higher than the ranking of the TN cell calculated without the specific offset, the UE may (determine to) not to apply the offset while calculating the cell ranking of the TN cell, if the UE is in specific mobility state(s) (e.g., the high-mobility state).

In some implementations, the UE's mobility state may be determined based on how frequently the strongest TN cell observed by the UE has changed (to another TN cell) in an observation duration. In other words, the UE may ignore the NTN cell during MSE (even if the UE has camped/selected on the NTN cell) no matter whether TN/NTN are deployed in the same frequency range or not. For instance, the UE's mobility state may be determined as follows:
High-mobility: if the strongest TN cell observed/detected during the time interval T_{CHmax} has changed not less than N_{CH_H} times. N_{CH_H} is the constant value configured/broadcast by the network.
Medium-mobility: if the strongest TN cell observed/detected during the time interval T_{CHmax} has changed not less than N_{CH_M} times but less than N_{CH_H} times. N_{CH_M} is another constant value configured/broadcast by the network.
Normal-mobility: if the strongest TN cell observed/detected during the time interval T_{CHmax} has changed less than N_{CH_M} times.

In some other implementations, the UE's mobility state may be determined based on the distance between two contiguous GNSS readings. For example, the UE's mobility state may be determined as follows:
High-mobility: |GNSS_Coordinate_{now}−GNSS_Coordinateₚᵣₑ|>D_{delta_H}, where GNSS_Coordinate_{now} is the current reading of UE's GNSS coordinate, GNSS_Coordinateₚᵣₑ is the previous reading of UE's GNSS coordinate, D_{delta_H} is the constant value configured/broadcast by the network, and the two contiguous GNSS readings need to be performed within the timer interval T_{GNSS_interval}, which is configured/broadcast by the network.
Medium-mobility: D_{delta_H}>|GNSS_Coordinate_{now}−GNSS_Coordinateₚᵣₑ|≥D_{delta_M}, where D_{delta_M} is the constant value configured/broadcast by the network.
Normal-mobility: D_{delta_M}>|GNSS_Coordinate_{now}−GNSS_Coordinateₚᵣₑ|.

In some implementations, the UE may determine which MSE scheme (e.g., the total number-of-cell-reselection based, the GNSS based, or the strongest TN cells based MSE scheme) to be applied based on whether the UE camps on/connects to a TN cell or an NTN cell. In some other implementations, the serving RAN (e.g., serving TN and/or NTN) may configure, to the UE, which MSE scheme(s) to be applied. It should be noted that one or more common MSE schemes may be configured (e.g., by the serving TN or NTN) for both serving TN/NTN in some conditions. In some additional conditions, the serving TN and the serving NTN may configure different MSE schemes independently (which means that the UE may apply different MSE schemes, one being associated with the serving NTN and another one being associated with the serving TN, respectively). In some implementations, an NTN capable UE, a UE which prioritizes TN, and/or an NTN capable UE which prioritizes TN may apply a new MSE scheme, while other UE(s) may keep using the conventional MSE scheme. In some implementations, if cell size related information is provided or specific information is provided by the network, the UE may know that the advanced MSE mechanism (by using the information provided by the network) is applied.

In some implementations, all (or any combinations) of the mobility states estimated by different MSE schemes may be applied/kept at the UE side. However, the UE may apply one result (e.g., one mobility state) based on whether the UE camps on/connects to a TN cell or an NTN cell. For example, the result obtained from the conventional approach (e.g., the MSE based on the total number of cell reselections) may be applied while the UE camps on the TN cell. The result obtained from the GNSS-based approach may be applied while the UE camps on the NTN cell. For example, in the scenario where TN and NTN are deployed on different frequency carriers/ranges, the UE may determine which result of the MSE to be applied based on which frequency the UE is using while camping on the serving cell.

In some implementations, the above implementations may be operated based on whether the UE is staying in the area of TN-only/NTN-only or supported by both TN and NTN.

In some other implementations, the above implementations may not be operated based on whether the UE is staying in the area of TN-only/NTN-only or supported by both TN and NTN.

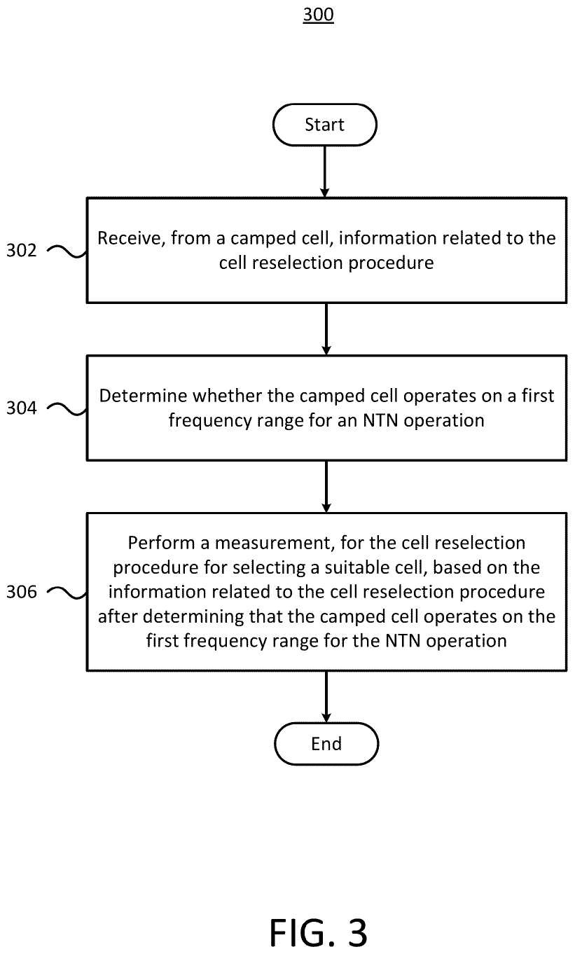

FIG. 3 is a flowchart illustrating a method/process 300 for handling a cell reselection procedure performed by a UE according to an example implementation of the present disclosure. In some implementations, the process 300 may be performed by a UE.

In action 302, the process 300 may start by receiving, from a camped cell, (assistance) information related to the cell reselection procedure. In action 304, the process 300 may determine whether the camped cell operates on a first frequency range (or frequency) for (e.g., supporting) an NTN operation. In action 306, the process 300 may perform a measurement, for the cell reselection procedure for selecting a suitable cell, based on the information related to the cell reselection procedure after determining that the camped cell operates on the first frequency range for the NTN operation. The process 300 may then end.

In some implementations, the measurement may be performed every time period, and the time period may be determined based on the information related to the cell reselection procedure. That is, the measurement may have a periodicity of the time period.

In some implementations, the information related to the cell reselection procedure may indicate at least one of: one or more frequency ranges, a density level of a TN deployment (e.g., within the NTN cell), area information of a neighboring cell, a (remaining) serving time of the camped cell, a network operation corresponding to (e.g., supported by) each of the one or more frequency ranges, the network operation being an NTN operation or a TN operation (e.g., whether each of the one or more frequency ranges is for the NTN operation or the TN operation), or a priority corresponding to each of the one or more frequency ranges. For example, the information related to the cell reselection procedure may indicate that a second frequency range supports the TN operation and a third frequency range supports the NTN operation.

In some implementations, the time period may be determined based on a density level of a TN deployment indicated by the information related to the cell reselection procedure. In some implementations, the time period may be determined based on area information of a neighboring cell indicated by the information related to the cell reselection procedure. In some implementations, the time period may be determined based on a serving time of the camped cell indicated by the information related to the cell reselection procedure.

In some implementations, the measurement may be performed on at least one of the one or more frequency ranges that is for the TN operation. In some implementations, the measurement may be performed on at least one of the one or more frequency ranges that has a priority higher than a first priority of the first frequency range.

In some implementations, the one or more frequency ranges may include a second frequency range for the TN operation and the first frequency range for the NTN operation, and a second priority of the second frequency range may be higher than a first priority of the first frequency range.

In some implementations, the information related to the cell reselection procedure may be received via SI broadcast by the camped cell. In some implementations, the information related to the cell reselection procedure may be received via RRC signaling.

It should be noted that the order in which the process is described is not intended to be construed as a limitation, and any number of the described actions may be combined in any order to implement the method or an alternate method. Moreover, one or more of the actions illustrated in FIG. 3 may be omitted in some implementations.

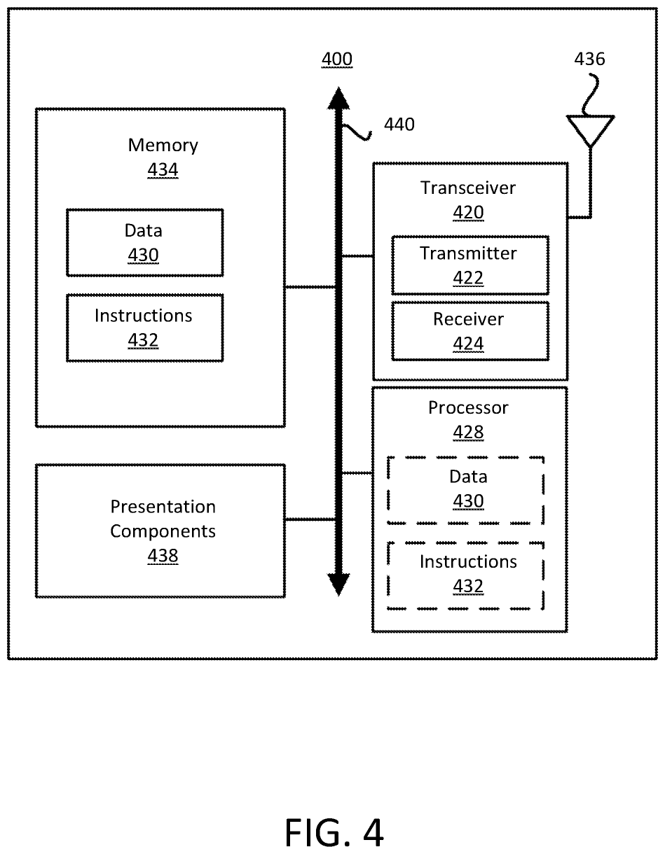

FIG. 4 is a block diagram illustrating a node 400 for wireless communication according to an example implementation of the present disclosure. As illustrated in FIG. 4, a node 400 may include a transceiver 420, a processor 428, a memory 434, one or more presentation components 438, and at least one antenna 436. The node 400 may also include a RF spectrum band module, a BS communications module, a network communications module, and a system communications management module, Input/Output (I/O) ports, I/O components, and a power supply (not illustrated in FIG. 4).

Each of the components may directly or indirectly communicate with each other over one or more buses 440. The node 400 may be a UE or a BS that performs various functions disclosed with reference to FIGS. 1 through 3.

The transceiver 420 has a transmitter 422 (e.g., transmitting/transmission circuitry) and a receiver 424 (e.g., receiving/reception circuitry) and may be configured to transmit and/or receive time and/or frequency resource partitioning information. The transceiver 420 may be configured to transmit in different types of subframes and slots including, but not limited to, usable, non-usable and flexibly usable subframes and slot formats. The transceiver 420 may be configured to receive data and control channels.

The node 400 may include a variety of computer-readable media. Computer-readable media may be any available media that may be accessed by the node 400 and include both volatile and non-volatile media, removable and non-removable media.

The computer-readable media may include computer storage media and communication media. Computer storage media include both volatile and non-volatile, removable and non-removable media implemented in any method or technology for storage of information, such as computer-readable instructions, data structures, program modules or data.

Computer storage media include RAM, ROM, EEPROM, flash memory or other memory technology, CD-ROM, Digital Versatile Disks (DVD) or other optical disk storage, magnetic cassettes, magnetic tape, magnetic disk storage or other magnetic storage devices. Computer storage media do not include a propagated data signal. Communication media typically embody computer-readable instructions, data structures, program modules or other data in a modulated data signal, such as a carrier wave or other transport mechanism and include any information delivery media.

The term “modulated data signal” means a signal that has one or more of its characteristics set or changed in such a manner as to encode information in the signal. Communication media include wired media, such as a wired network or direct-wired connection, and wireless media, such as acoustic, RF, infrared and other wireless media. Combinations of any of the previously listed components should also be included within the scope of computer-readable media.

The memory 434 may include computer-storage media in the form of volatile and/or non-volatile memory. The memory 434 may be removable, non-removable, or a combination thereof. Example memory includes solid-state memory, hard drives, optical-disc drives, etc. As illustrated in FIG. 4, the memory 434 may store computer-readable, computer-executable instructions 432 (e.g., software codes) that are configured to cause the processor 428 to perform various disclosed functions, for example, with reference to FIGS. 1 through 3. Alternatively, the instructions 432 may not be directly executable by the processor 428 but be configured to cause the node 400 (e.g., when compiled and executed) to perform various disclosed functions.

The processor 428 (e.g., having processing circuitry) may include an intelligent hardware device, e.g., a Central Processing Unit (CPU), a microcontroller, an ASIC, etc. The processor 428 may include memory. The processor 428 may process data 430 and the instructions 432 received from the memory 434, and information transmitted and received via the transceiver 420, the base band communications module, and/or the network communications module. The processor 428 may also process information to be sent to the transceiver 420 for transmission via the antenna 436 to the network communications module for transmission to a CN.

One or more presentation components 438 present data indications to a person or another device. Examples of presentation components 438 include a display device, a speaker, a printing component, and a vibrating component, etc.

In view of the present disclosure, it is obvious that various techniques may be used for implementing the concepts in the present disclosure without departing from the scope of those concepts. Moreover, while the concepts have been disclosed with specific reference to certain implementations, a person of ordinary skill in the art will recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

1. A method for handling a cell reselection procedure performed by a user equipment (UE), the method comprising:
receiving, from a camped cell, information related to the cell reselection procedure;
determining whether the camped cell operates on a first frequency range for a Non-Terrestrial Network (NTN) operation; and
performing a measurement for the cell reselection procedure for selecting a suitable cell, based on the information related to the cell reselection procedure after determining that the camped cell operates on the first frequency range for the NTN operation.

2. The method of claim 1, wherein:
the measurement is performed every time period, and
the time period is determined based on the information related to the cell reselection procedure.

3. The method of claim 2, wherein the time period is determined based on a density level of a Terrestrial Network (TN) deployment indicated by the information related to the cell reselection procedure.

4. The method of claim 2, wherein the time period is determined based on area information of a neighboring cell indicated by the information related to the cell reselection procedure.

5. The method of claim 2, wherein the time period is determined based on a serving time of the camped cell indicated by the information related to the cell reselection procedure.

6. The method of claim 1, wherein the information related to the cell reselection procedure indicates at least one of:
one or more frequency ranges,
a density level of a Terrestrial Network (TN) deployment,
area information of a neighboring cell,
a serving time of the camped cell,
a network operation corresponding to each of the one or more frequency ranges, the network operation being an NTN operation or a TN operation, or
a priority corresponding to each of the one or more frequency ranges.

7. The method of claim 6, wherein the measurement is performed on at least one of the one or more frequency ranges that is for the TN operation.

8. The method of claim 6, wherein:
the measurement is performed on at least one of the one or more frequency ranges that has a priority higher than a first priority of the first frequency range.

9. The method of claim 6, wherein:
the one or more frequency ranges include a second frequency range for the TN operation and the first frequency range for the NTN operation, and
a second priority of the second frequency range is higher than a first priority of the first frequency range.

10. The method of claim 1, wherein the information related to the cell reselection procedure is received via system information (SI) broadcast by the camped cell.

11. The method of claim 1, wherein the information related to the cell reselection procedure is received via radio resource control (RRC) signaling.

12. A user equipment (UE) for handling a cell reselection procedure, comprising:
one or more processors; and
at least one non-transitory computer-readable medium coupled to at least one of the one or more processors, and storing one or more computer-executable instructions that, when executed by the at least one of the one or more processors, cause the UE to:
receive, from a camped cell, information related to the cell reselection procedure;
determine whether the camped cell operates on a first frequency range for a Non-Terrestrial Network (NTN) operation; and
perform a measurement, for the cell reselection procedure for selecting a suitable cell, based on the information related to the cell reselection procedure after determining that the camped cell operates on the first frequency range for the NTN operation.

13. The UE of claim 12, wherein:
the measurement is performed every time period, and
the time period is determined based on the information related to the cell reselection procedure.

14. The UE of claim 13, wherein the time period is determined based on at least one of:
a density level of a Terrestrial Network (TN) deployment indicated by the information related to the cell reselection procedure,
area information of a neighboring cell indicated by the information related to the cell reselection procedure, or
a serving time of the camped cell indicated by the information related to the cell reselection procedure.

15. The UE of claim 12, wherein the information related to the cell reselection procedure indicates at least one of:
one or more frequency ranges,
a density level of a Terrestrial Network (TN) deployment,
area information of a neighboring cell,
a serving time of the camped cell,
a network operation corresponding to each of the one or more frequency ranges, the network operation being an NTN operation or a TN operation, or
a priority corresponding to each of the one or more frequency ranges.

16. The UE of claim 15, wherein the measurement is performed on at least one of the one or more frequency ranges that is for the TN operation.

17. The UE of claim 15, wherein:
the measurement is performed on at least one of the one or more frequency ranges that has a priority higher than a first priority of the first frequency range.

18. The UE of claim 15, wherein:
The one or more frequency ranges include a second frequency range for the TN operation and the first frequency range for the NTN operation, and
a second priority of the second frequency range is higher than a first priority of the first frequency range.

19. The UE of claim 12, wherein the information related to the cell reselection procedure is received via system information (SI) broadcast by the camped cell.

20. The UE of claim 12, wherein the information related to the cell reselection procedure is received via radio resource control (RRC) signaling.
